(19) United States
(12) Patent Application Publication
(10) Pub. No.: US 2024/0174778 A1
(43) Pub. Date: May 30, 2024

(54) HIGH DENSITY POLYETHYLENE COMPOSITION

(71) Applicant: NOVA Chemicals (International) S.A., Fribourg (CH)

(72) Inventors: Céline Bellehumeur, Calgary (CA); Sepideh Kasiri, Calgary (CA)

(73) Assignee: NOVA Chemicals (International) S.A., Fribourg (CH)

(21) Appl. No.: 18/550,477

(22) PCT Filed: Mar. 16, 2022
(86) PCT No.: PCT/IB2022/052397

§ 371 Date: Sep. 14, 2023

Related U.S. Application Data
(60) Provisional application No. 63/163,115, filed on Mar. 19, 2021.

(51) Int. Cl. C08F 210/02

(52) U.S. Cl. CPC C08F 210/02; C08F 2410/05

(57) ABSTRACT

A polyethylene composition has a density of ≥0.945 g/cm³, a melt index. I₂ of from 0.8 to 4.0 g/10 min. an environmental stress crack resistance, an ESCR of greater than 400 hours as determined by ASTM D1693 in 100% IGEPAL CO-630 under conditions A or B. and a melt strength of ≥3.0 cN.

### TECHNICAL FIELD

The present disclosure is directed to high density polyethylene compositions which have high melt strength, good impact resistance (Izod), and good environmental stress crack resistance (ESCR). The polyethylene compositions are suitable for extrusion molding applications.

### BACKGROUND ART

When developing a thermoplastic resin suitable for use in preparing a molded article such as, for example, a rotomolded article, some of the main considerations include: the time required to mold the part (which includes for example, the flow rate of the molten resin within a mold, and the rates for resin sintering and cooling); the impact resistance; and the resistance to environmental stresses over time (such as for example, the environmental stress crack resistance).

Although several polyethylene resins which are suitable for use in molded parts have been developed (see for example U.S. Pat. Appl. Pub. Nos 2016/0229964; 20170267822 and U.S. Pat. Nos. 9,181,422; 9,540,505; 9,695,309; 10,519,304; 10,329,412; 10,053,564; 9,758,653; 9,637,628; 9,475,927; 9,221,966; 9,074,082; 8,962,755 8,022,143), there remains a need for new high density polyethylene resins which simultaneously exhibit good impact resistance and environmental resistance properties.

### SUMMARY OF INVENTION

We have now developed a polyethylene composition having high density and high melt strength, as well as good environmental stress crack and impact resistance properties. The polyethylene compositions may be useful in the manufacture of molded articles.

An embodiment of the disclosure is a polyethylene composition comprising: (i) from 5 to 50 weight % of first ethylene copolymer having a weight average molecular weight, Mw of >200,000 g/mol; and (ii) from 95 to 50 weight % of a second ethylene copolymer; wherein the first ethylene copolymer has a higher weight average molecular weight, Mw than the second ethylene copolymer; wherein the first ethylene copolymer has a higher number of short chain branches per 1000 carbon atoms (SCB1) than the second ethylene copolymer (SCB2); wherein the polyethylene composition has a density of ≥0.945 g/cm³; a melt index, I₂ of from 0.8 to 4.0 g/10 min; a melt flow ratio, I₂₁/I₂ of ≥50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; and an environmental stress crack resistance, ESCR of greater than 400 hours as determined by ASTM D1693 in 100% IGEPAL® CO-630 under conditions A and B.

An embodiment of the disclosure is a molded article prepared from a polyethylene composition comprising: (i) from 5 to 50 weight % of first ethylene copolymer having a weight average molecular weight, Mw of >200,000 g/mol; and (ii) from 95 to 50 weight % of a second ethylene copolymer; wherein the first ethylene copolymer has a higher weight average molecular weight, Mw than the second ethylene copolymer; wherein the first ethylene copolymer has a higher number of short chain branches per 1000 carbon atoms (SCB1) than the second ethylene copolymer (SCB2); wherein the polyethylene composition has a density of ≥0.945 g/cm³; a melt index, I₂ of from 0.8 to 4.0 g/10 min; a melt flow ratio, I₂₁/I₂ of ≥50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; and an environmental stress crack resistance, ESCR of greater than 400 hours as determined by ASTM D1693 in 100% IGEPAL CO-630 under conditions A and B.

An embodiment of the disclosure is an extrusion molded article prepared from a polyethylene composition comprising: (i) from 5 to 50 weight % of first ethylene copolymer having a weight average molecular weight, Mw of >200,000 g/mol; and (ii) from 95 to 50 weight % of a second ethylene copolymer; wherein the first ethylene copolymer has a higher weight average molecular weight, Mw than the second ethylene copolymer; wherein the first ethylene copolymer has a higher number of short chain branches per 1000 carbon atoms (SCB1) than the second ethylene copolymer (SCB2); wherein the polyethylene composition has a density of ≥0.945 g/cm³; a melt index, 12 of from 0.8 to 4.0 g/10 min; a melt flow ratio, I₂₁/I₂ of >50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; and an environmental stress crack resistance, ESCR of greater than 400 hours as determined by ASTM D1693 in 100% IGEPAL CO-630 under conditions A and B.

An embodiment of the disclosure is an injection molded article prepared from a polyethylene composition comprising: (i) from 5 to 50 weight % of first ethylene copolymer having a weight average molecular weight, Mw of >200,000 g/mol; and (ii) from 95 to 50 weight % of a second ethylene copolymer; wherein the first ethylene copolymer has a higher weight average molecular weight, Mw than the second ethylene copolymer; wherein the first ethylene copolymer has a higher number of short chain branches per 1000 carbon atoms (SCB1) than the second ethylene copolymer (SCB2); wherein the polyethylene composition has a density of ≥0.945 g/cm³; a melt index, 12 of from 0.8 to 4.0 g/10 min; a melt flow ratio, I₂₁/I₂ of >50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; and an environmental stress crack resistance, ESCR of greater than 400 hours as determined by ASTM D1693 in 100% IGEPAL CO-630 under conditions A and B.

An embodiment of the disclosure is a compression molded article prepared from a polyethylene composition comprising: (i) from 5 to 50 weight % of first ethylene copolymer having a weight average molecular weight, Mw of >200,000 g/mol; and (ii) from 95 to 50 weight % of a second ethylene copolymer; wherein the first ethylene copolymer has a higher weight average molecular weight, Mw than the second ethylene copolymer; wherein the first ethylene copolymer has a higher number of short chain branches per 1000 carbon atoms (SCB1) than the second ethylene copolymer (SCB2); wherein the polyethylene composition has a density of ≥0.945 g/cm³; a melt index, I₂ of from 0.8 to 4.0 g/10 min; a melt flow ratio, I₂₁/I₂ of >50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; and an environmental stress crack resistance, ESCR of greater than 400 hours as determined by ASTM D1693 in 100% IGEPAL CO-630 under conditions A and B.

An embodiment of the disclosure is a cap or closure prepared from a polyethylene composition comprising: (i) from 5 to 50 weight % of first ethylene copolymer having a weight average molecular weight, Mw of >200,000 g/mol; and (ii) from 95 to 50 weight % of a second ethylene copolymer; wherein the first ethylene copolymer has a higher weight average molecular weight, Mw than the second ethylene copolymer; wherein the first ethylene copolymer has a higher number of short chain branches per 1000 carbon atoms (SCB1) than the second ethylene copolymer (SCB2); wherein the polyethylene composition has a density of ≥0.945 g/cm³; a melt index, I₂ of from 0.8 to 4.0 g/10 min; a melt flow ratio, I₂₁/I₂ of ≥50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; and an environmental stress crack resistance, ESCR of greater than 400 hours as determined by ASTM D1693 in 100% IGEPAL CO-630 under conditions A and B.

An embodiment of the disclosure is a polyethylene composition comprising: (i) from 5 to 50 weight % of first ethylene copolymer having a weight average molecular weight, Mw of >200,000 g/mol; and (ii) from 95 to 50 weight % of a second ethylene copolymer; wherein the first ethylene copolymer has a higher weight average molecular weight, Mw than the second ethylene copolymer; wherein the first ethylene copolymer has a higher number of short chain branches per 1000 carbon atoms (SCB1) than the second ethylene copolymer (SCB2); wherein the polyethylene composition has a density of ≥0.945 g/cm³; a melt index, I₂ of from 0.8 to 4.0 g/10 min; a melt flow ratio, I₂₁/I₂ of ≥50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; a composition distribution breadth index, CDBI₅₀ of <50%; an Izod impact strength of >3.0 foot pounds per inch; and an environmental stress crack resistance, ESCR of greater than 1000 hours as determined by ASTM D1693 in 100% IGEPAL CO-630 under conditions A and B.

An embodiment of the disclosure is a polyethylene composition comprising: (i) from 5 to 50 weight % of first ethylene copolymer having a weight average molecular weight, Mw of >200,000 g/mol; and (ii) from 95 to 50 weight % of a second ethylene copolymer; wherein the first ethylene copolymer has a higher weight average molecular weight, Mw than the second ethylene copolymer; wherein the first ethylene copolymer has a higher number of short chain branches per 1000 carbon atoms (SCB1) than the second ethylene copolymer (SCB2); wherein the polyethylene composition has a density of ≥0.945 g/cm³; a melt index, I₂ of from 0.8 to 4.0 g/10 min; a melt flow ratio, I₂₁/I₂ of ≥50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; a composition distribution breadth index, CDBI₅₀ of >50%; an Izod impact strength of >1.5 foot pounds per inch; and an environmental stress crack resistance, ESCR of greater than 400 hours as determined by ASTM D1693 in 100% IGEPAL CO-630 under conditions A and B.

In an embodiment of the disclosure a polyethylene composition has a long chain branching factor, LCBF of >0.0050.

### BRIEF DESCRIPTION OF THE DRAWINGS

FIG. 1 shows the gel permeation chromatograph with refractive index detection (GPC-RI) obtained for polyethylene compositions made according to the present disclosure as well as for various comparative resins.

FIG. 2 shows the gel permeation chromatograph with Fourier transform infra-red (GPC-FTIR) detection obtained for polyethylene compositions made according to the present disclosure as well as for various comparative resins. The comonomer content, shown as the number of short chain branches per 1000 backbone carbons (y-axis), is given relative to the polymer molecular weight (x-axis).

FIG. 3 shows the temperature rising elution fractionation (TREF) profile for polyethylene compositions made according to the present disclosure as well as for various comparative resins.

FIG. 4 shows the DMA frequency sweep data (viscosity, η* in Pa·s vs. the frequency, ω in radians/s) for polyethylene compositions made according to the present disclosure as well as for a comparative resin.

FIG. 5 shows the relationship between two performance indicators (the Izod Impact strength and the Flexural Secant Modulus at 1%) for compression molded plaques made from polyethylene compositions of the present disclosure as well as from various comparative resins.

FIG. 6 shows the relationship between two performance indicators (the ESCR Condition B, 100% IGEPAL vs the Flexural Secant Modulus at 1%) for compression molded plaques made from polyethylene compositions of the present disclosure as well as from various comparative resins.

### DESCRIPTION OF EMBODIMENTS

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the term “monomer” refers to a small molecule that may chemically react and become chemically bonded with itself or other monomers to form a polymer.

As used herein, the term “α-olefin” is used to describe a monomer having a linear hydrocarbon chain containing from 3 to 20 carbon atoms having a double bond at one end of the chain; an equivalent term is “linear α-olefin”.

By the terms “ethylene homopolymer” or “polyethylene homopolymer”, it is meant that polymer being referred to is the product of a polymerization process, in which only ethylene was deliberately added or deliberately present as a polymerizable monomer.

By the terms “ethylene copolymer” or “polyethylene copolymer”, it is meant that the polymer being referred to is the product of a polymerization process, in which ethylene and one or more than one α-olefin were deliberately added or were deliberately present as a polymerizable monomer.

As used herein the term “unsubstituted” means that hydrogen radicals are bonded to the molecular group that follows the term unsubstituted. The term “substituted” means that the group following this term possesses one or more moieties (non-hydrogen radicals) that have replaced one or more hydrogen radicals in any position within the group.

The present disclosure provides a polyethylene composition comprising two components: (i) a first ethylene copolymer; and (ii) a second ethylene copolymer which is different from the first ethylene copolymer.

In an embodiment of the disclosure, the polyethylene composition is useful in the manufacture of extrusion molded articles.

In an embodiment of the disclosure, the polyethylene composition is useful in the manufacture of compression molded articles.

In an embodiment of the disclosure, the polyethylene composition is useful in the manufacture of injection molded articles.

### The First Ethylene Copolymer

In an embodiment of the disclosure the first ethylene copolymer comprises both polymerized ethylene and at least one polymerized α-olefin comonomer, with polymerized ethylene being the majority species.

In embodiments of the disclosure, α-olefins which may be copolymerized with ethylene to make the first ethylene copolymer may be selected from the group comprising 1-propene, 1-butene, 1-pentene, 1-hexene and 1-octene and mixtures thereof.

In an embodiment of the disclosure, the first ethylene copolymer is made with a single site catalyst, non-limiting examples of which include phosphinimine catalysts, metallocene catalysts, and constrained geometry catalysts, all of which are well known in the art.

In an embodiment of the disclosure the first ethylene copolymer is made using a single site polymerization catalyst.

In an embodiment of the disclosure the first ethylene copolymer is made using a single site polymerization catalyst in a solution phase polymerization process.

In an embodiment of the disclosure, the first ethylene copolymer is made with a single site catalyst, having hafnium, Hf as the active metal center.

In an embodiment of the disclosure, the first ethylene copolymer is an ethylene/1-octene copolymer.

In an embodiment of the disclosure, the first ethylene copolymer is made with a metallocene catalyst.

In an embodiment of the disclosure, the first ethylene copolymer is made with a bridged metallocene catalyst.

In an embodiment of the disclosure, the first ethylene copolymer is made with a bridged metallocene catalyst having the Formula I:

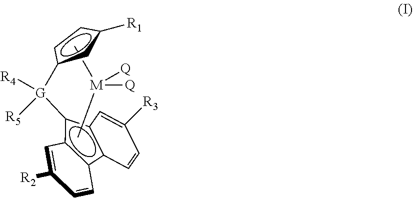

In Formula (I): M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, G is carbon.

In an embodiment, R₄ and R₅ are independently an aryl group.

In an embodiment, R₄ and R₅ are independently a phenyl group or a substituted phenyl group.

In an embodiment, R₄ and R₅ are a phenyl group.

In an embodiment, R₄ and R₅ are independently a substituted phenyl group.

In an embodiment, R₄ and R₅ are a substituted phenyl group, wherein the phenyl group is substituted with a substituted silyl group.

In an embodiment, R₄ and R₅ are a substituted phenyl group, wherein the phenyl group is substituted with a trialkyl silyl group.

In an embodiment, R₄ and R₅ are a substituted phenyl group, wherein the phenyl group is substituted at the para position with a trialkylsilyl group. In an embodiment, R₄ and R₅ are a substituted phenyl group, wherein the phenyl group is substituted at the para position with a trimethylsilyl group. In an embodiment, R₄ and R₅ are a substituted phenyl group, wherein the phenyl group is substituted at the para position with a triethylsilyl group.

In an embodiment, R₄ and R₅ are independently an alkyl group.

In an embodiment, R₄ and R₅ are independently an alkenyl group.

In an embodiment, R₁ is hydrogen.

In an embodiment, R₁ is an alkyl group.

In an embodiment, R₁ is an aryl group.

In an embodiment, R₁ is an alkenyl group.

In an embodiment, R₂ and R₃ are independently a hydrocarbyl group having from 1 to 30 carbon atoms.

In an embodiment, R₂ and R₃ are independently an aryl group.

In an embodiment, R₂ and R₃ are independently an alkyl group.

In an embodiment, R₂ and R₃ are independently an alkyl group having from 1 to 20 carbon atoms.

In an embodiment, R₂ and R₃ are independently a phenyl group or a substituted phenyl group.

In an embodiment, R₂ and R₃ are a tert-butyl group.

In an embodiment, R₂ and R₃ are hydrogen.

In an embodiment M is hafnium, Hf.

In an embodiment of the disclosure, the first ethylene copolymer is made with a bridged metallocene catalyst having the Formula I:

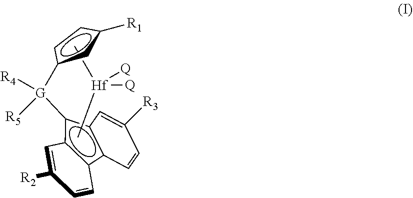

In Formula (I): G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g. a halide may be converted to an alkyl group). Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g. 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g. chloride) or a hydrocarbyl (e.g. methyl, benzyl).

In an embodiment of the disclosure, the single site catalyst used to make the first ethylene copolymer is diphenylmethylene(cyclopentadienyl)(2,7-di-t-butylfluorenyl)hafnium dichloride having the molecular formula:

[(2,7-tBu₂Flu)Ph₂C(Cp)HfCl₂].

In an embodiment of the disclosure the single site catalyst used to make the first ethylene copolymer is diphenylmethylene(cyclopentadienyl)(2,7-di-t-butylfluorenyl)hafnium dimethyl having the molecular formula:

[(2,7-tBu₂Flu)Ph₂C(Cp)HfMe₂].

In addition to the single site catalyst molecule per se, an active single site catalyst system may further comprise one or more of the following: an alkylaluminoxane co-catalyst and an ionic activator. The single site catalyst system may also optionally comprise a hindered phenol.

Although the exact structure of alkylaluminoxane is uncertain, subject matter experts generally agree that it is an oligomeric species that contain repeating units of the general formula:

(R)₂AlO—(Al(R)—O)ₙ—Al(R)₂

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In an embodiment of the disclosure, R of the alkylaluminoxane, is a methyl radical and m is from 10 to 40.

In an embodiment of the disclosure, the co-catalyst is modified methylaluminoxane (MMAO).

It is well known in the art, that the alkylaluminoxane can serve dual roles as both an alkylator and an activator. Hence, an alkylaluminoxane co-catalyst is often used in combination with activatable ligands such as halogens.

In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas shown below;

[R⁵]⁺[B(R⁷)₄]⁻

where B represents a boron atom, R⁵ is an aromatic hydrocarbyl (e.g. triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula —Si(R⁹)₃, where each R⁹ is independently selected from hydrogen atoms and C₁₋₄ alkyl radicals, and where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above.

In both formula a non-limiting example of R⁷ is a pentafluorophenyl radical. In general, boron ionic activators may be described as salts of tetra(perfluorophenyl) boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: tricthylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl)n-butylboron, N,N-2,4,6-pentamethylanilinium tetra(phenyl)boron, di-(isopropyl)ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropylium tetrakispentafluorophenyl borate, triphenylmethylium tetrakispentafluorophenyl borate, benzene(diazonium)tetrakispentafluorophenyl borate, tropylium tetrakis(2,3,5,6-tetrafluorophenyl)borate, triphenylmethylium tetrakis(2,3,5,6-tetrafluorophenyl)borate, benzene(diazonium) tetrakis(3,4,5-trifluorophenyl)borate, tropylium tetrakis(3,4,5-trifluorophenyl)borate, benzene(diazonium) tetrakis(3,4,5-trifluorophenyl)borate, tropylium tetrakis(1,2,2-trifluoroethenyl)borate, triphenylmethylium tetrakis(1,2,2-trifluoroethenyl)borate, benzene(diazonium) tetrakis(1,2,2-trifluorocthenyl)borate, tropylium tetrakis(2,3,4,5-tetrafluorophenyl)borate, triphenylmethylium tetrakis(2,3,4,5-tetrafluorophenyl)borate, and benzene(diazonium) tetrakis(2,3,4,5 tetrafluorophenyl)borate. Readily available commercial ionic activators include N,N-dimethylanilinium tetrakispentafluorophenyl borate, and triphenylmethylium tetrakispentafluorophenyl borate.

Non-limiting example of hindered phenols include butylated phenolic antioxidants, butylated hydroxytoluene, 2,6-di-tertiarybutyl-4-ethyl phenol, 4,4′-methylenebis (2,6-di-tertiary-butylphenol), 1,3,5-trimethyl-2,4,6-tris (3,5-di-tert-butyl-4-hydroxybenzyl) benzene and octadecyl-3-(3′,5′-di-tert-butyl-4′-hydroxyphenyl) propionate.

To produce an active single site catalyst system the quantity and mole ratios of the three or four components: the single site catalyst molecule (e.g. the metallocne), the alkylaluminoxane, the ionic activator, and the optional hindered phenol are optimized.

In an embodiment of the disclosure, the single site catalyst used to make the first ethylene copolymer produces long chain branches, and the first ethylene copolymer will contain long chain branches, hereinafter ‘LCB’.

LCB is a well-known structural phenomenon in ethylene copolymers and well known to those of ordinary skill in the art. Traditionally, there are three methods for LCB analysis, namely, nuclear magnetic resonance spectroscopy (NMR), for example see J. C. Randall, J Macromol. Sci., Rev. Macromol. Chem. Phys. 1989, 29, 201; triple detection SEC equipped with a DRI, a viscometer and a low-angle laser light scattering detector, for example see W. W. Yau and D. R. Hill, Int. J. Polym. Anal. Charact. 1996; 2:151; and rheology, for example see W. W. Graessley, Acc. Chem. Res. 1977, 10, 332-339. In embodiments of this disclosure, a long chain branch is macromolecular in nature, i.e. long enough to be seen in an NMR spectra, triple detector SEC experiments or rheological experiments.

In an embodiment of the disclosure, the first ethylene copolymer contains long chain branching characterized by the long chain branching factor, LCBF disclosed herein. In embodiments of the disclosure, the upper limit on the LCBF of the first ethylene copolymer may be 0.5000, or 0.4000, or 0.3000 (dimensionless). In embodiments of the disclosure, the lower limit on the LCBF of the first ethylene copolymer may be 0.0010, or 0.0015, or 0.0020, or 0.0050, or 0.0070, or 0.0100, or 0.0500, or 0.1000 (dimensionless).

In embodiments of the disclosure, the LCBF of the first ethylene copolymer is at least 0.0010, or at least 0.0020, or at least 0.0050, or at least 0.0070, or at least 0.0100.

The first ethylene copolymer may contain catalyst residues that reflect the chemical composition of the catalyst formulation used to make it. Those skilled in the art will understand that catalyst residues are typically quantified by the parts per million of metal, in for example the first ethylene copolymer (or the polyethylene composition; see below), where the metal present originates from the metal in the catalyst formulation used to make it. Non-limiting examples of the metal residue which may be present include Group 4 metals, titanium, zirconium and hafnium. In embodiments of the disclosure, the upper limit on the ppm of metal in the first ethylene copolymer may be about 3.0 ppm, in other cases about 2.0 ppm and in still other cases about 1.5 ppm. In embodiments of the disclosure, the lower limit on the ppm of metal in the first ethylene copolymer may be about 0.03 ppm, in other cases about 0.09 ppm and in still other cases about 0.15 ppm.

In an embodiment of the disclosure, the first ethylene copolymer has from 1 to 50 short chain branches per thousand carbon atoms (SCB1). In further embodiments, the first ethylene copolymer has from 1 to 25 short chain branches per thousand carbon atoms (SCB1), or from 1 to 15 short chain branches per thousand carbon atoms (SCB1), or from 1 to 10 short chain branches per thousand carbon atoms (SCB1).

The short chain branching (i.e. the short chain branching per thousand backbone carbon atoms, SCB1) is the branching due to the presence of an α-olefin comonomer in the ethylene copolymer and will for example have two carbon atoms for a 1-butene comonomer, or four carbon atoms for a 1-hexene comonomer, or six carbon atoms for a 1-octene comonomer, etc.

In an embodiment of the disclosure, the number of short chain branches per thousand carbon atoms in the first ethylene copolymer (SCB1), is greater than the number of short chain branches per thousand carbon atoms in the second ethylene copolymer (SCB2).

In an embodiment of the disclosure, the density of the first copolymer is less than the density of the second ethylene copolymer.

In an embodiment of the disclosure, the first ethylene copolymer has a density of from 0.895 to 0.936 g/cm³, including any narrower ranges within this range and any values encompassed by these ranges. For example, in embodiments of the disclosure, the first ethylene copolymer has a density of from 0.895 to 0.932 g/cm³, or from 0.895 to 0.930 g/cm³, or from 0.895 to 0.926 g/cm³, or from 0.900 to 0.936 g/cm³, or from 0.900 to 0.932 g/cm³, or from 0.900 to 0.930 g/cm³, or from 0.900 to 0.926 g/cm³, or from 0.910 to 0.936 g/cm³, or from 0.910 to 0.932 g/cm³, or from 0.910 to 0.930 g/cm³, or from 0.910 to 0.926 g/cm.

In an embodiment of the disclosure, the melt index, 12 of the first ethylene copolymer is less than the melt index, I₂ of second ethylene copolymer.

In embodiments of the disclosure the first ethylene copolymer has a melt index, I₂ of, ≤5.0 g/10 min, or ≤2.5 g/10 min, or ≤1.0 g/10 min, or <1.0 g/10 min, or ≤0.5 g/10 min, or <0.5 g/10 min, or ≤0.4 g/10 min, or <0.4 g/10 min.

In embodiments of the disclosure, the first ethylene copolymer has a melt index, I₂ of from 0.001 to 5.0 g/10 min, including any narrower ranges within this range and any values encompassed by these ranges. For example, in embodiments of the disclosure, the melt index, I₂ of the first ethylene copolymer may be from 0.01 to 5.0 g/10 min, or from 0.01 to 2.5 g/10 min, or from 0.01 to 2.0 g/10 min, or from 0.01 to 1.5 g/10 min, 0.01 to 1.0 g/10 min, or from 0.01 to 0.5 g/10 min, or from 0.01 to 0.1 g/10 min.

In embodiments of the disclosure, the first ethylene copolymer has a weight average molecular weight, M_{w} of greater than 200,000 g/mol, or greater than 225,000 g/mol, or greater than 250,000 g/mol.

In embodiments of the disclosure, the first ethylene copolymer has a weight average molecular weight, M_{w} of from 200,000 to 350,000 including any narrower ranges within this range and any values encompassed by these ranges. For example, in embodiments of the disclosure, the first ethylene copolymer has a weight average molecular weight, M_{w} of from 200,000 to 325,000 g/mol, or from 200,000 to 300,000 g/mol, or from 225,000 to 300,000 g/mol.

In an embodiment of the disclosure, the first ethylene copolymer has a melt flow ratio, I₂₁/I₂ of less than 25, or less than 23, or less than 20.

In embodiments of the disclosure, the upper limit on the molecular weight distribution, M_{w}/Mₙ of the first ethylene copolymer may be about 2.7, or about 2.5, or about 2.4, or about 2.3, or about 2.2. In embodiments of the disclosure, the lower limit on the molecular weight distribution, M_{w}/Mₙ of the first ethylene copolymer may be about 1.6, or about 1.7, or about 1.8, or about 1.9.

In embodiments of the disclosure, the first ethylene copolymer has a molecular weight distribution, M_{w}/Mₙ of ≤3.0, or <3.0, or ≤2.7, or <2.7, or ≤2.5, or <2.5, or ≤2.3, or <2.3, or ≤2.1, or <2.1, or about 2. In another embodiment of the disclosure, the first ethylene copolymer has a molecular weight distribution, M_{w}/Mₙ of from 1.7 to 3.0, including any narrower ranges within this range and any values encompassed by these ranges. For example, in embodiments of the disclosure, the first ethylene copolymer has a molecular weight distribution, M_{w}/Mₙ of from 1.7 to 2.7, or from 1.8 to 2.7, or from 1.8 to 2.5, or from 1.8 to 2.3, or from 1.9 to 2.1, or about 2.0.

In an embodiment of the disclosure, a single site catalyst which gives an ethylene copolymer having a CDBI₅₀ of at least 60% by weight, or at least 65%, or at least 70%, or at least 75%, or at least 80%, or at least 85%, during solution phase polymerization in a single reactor, is used in the preparation of the first ethylene copolymer.

In embodiments of the disclosure, the weight percent (wt %) of the first ethylene copolymer in the polyethylene composition (i.e. the weight percent of the first ethylene copolymer based on the total weight of the first ethylene copolymer and the second ethylene copolymers) may be from about 5 wt % to about 60 wt %, including any narrower ranges within this range and any values encompassed by these ranges. For example, in embodiments of the disclosure, the weight percent (wt %) of the first ethylene copolymer in the polyethylene copolymer composition may be from about 5 wt % to about 50 wt %, or from about 10 wt % to about 40 wt %, or from about 15 wt % to about 40 wt %, or from about 15 wt % to about 35 wt %, or from about 10 wt % to about 35 wt %, or from about 20 wt % to about 30 wt %.

### The Second Ethylene Copolymer

In an embodiment of the disclosure the second ethylene copolymer comprises both polymerized ethylene and at least one polymerized α-olefin comonomer, with polymerized ethylene being the majority species.

In embodiments of the disclosure, α-olefins which may be copolymerized with ethylene to make the second ethylene copolymer may be selected from the group comprising 1-propene, 1-butene, 1-pentene, 1-hexene and 1-octene and mixtures thereof.

In an embodiment of the disclosure, the second ethylene copolymer is made with a single site catalyst, non-limiting examples of which include phosphinimine catalysts, metallocene catalysts, and constrained geometry catalysts, all of which are well known in the art.

In an embodiment of the disclosure the second ethylene copolymer is made using a single site polymerization catalyst.

In an embodiment of the disclosure the second ethylene copolymer is made using a single site polymerization catalyst in a solution phase polymerization process.

In an embodiment of the disclosure, the second ethylene copolymer is made with a single site catalyst, having titanium, Ti as the active metal center.

In an embodiment of the disclosure, the second ethylene copolymer is an ethylene/1-octene copolymer.

In an embodiment of the disclosure, the second ethylene copolymer is made with a phosphinimine catalyst.

In an embodiment of the disclosure, the second ethylene copolymer is made with a phosphinimine catalyst having the Formula II:

(L^{A})ₐM(PI)_{b}(Q)ₙ (II)

wherein (L^{A}) represents is cyclopentadienyl-type ligand; M represents a metal atom selected from the group consisting of Ti, Zr, and Hf; PI represents a phosphinimine ligand; Q represents an activatable ligand as already defined above; a is 0 or 1; b is 1 or 2; (a+b)=2; n is 1 or 2; and the sum of (a+b+n) equals the valance of the metal M.

As used herein, the term “cyclopentadienyl-type” ligand is meant to include ligands which contain at least one five-carbon ring which is bonded to the metal via eta-5 (or in some cases eta-3) bonding. Thus, the term “cyclopentadienyl-type” includes, for example, unsubstituted cyclopentadienyl, singly or multiply substituted cyclopentadienyl, unsubstituted indenyl, singly or multiply substituted indenyl, unsubstituted fluorenyl and singly or multiply substituted fluorenyl. Hydrogenated versions of indenyl and fluorenyl ligands are also contemplated for use in the current disclosure, so long as the five-carbon ring which bonds to the metal via eta-5 (or in some cases eta-3) bonding remains intact. Substituents for a cyclopentadienyl ligand, an indenyl ligand (or hydrogenated version thereof) and a fluorenyl ligand (or hydrogenated version thereof) may be selected from the group consisting of a C₁₋₃₀ hydrocarbyl radical (which hydrocarbyl radical may be unsubstituted or further substituted by for example a halide and/or a hydrocarbyl group; for example a suitable substituted C₁₋₃₀ hydrocarbyl radical is a pentafluorobenzyl group such as —CH₂C₆F₅); a halogen atom; a C₁₋₈ alkoxy radical; a C₆₋₁₀ aryl or aryloxy radical (each of which may be further substituted by for example a halide and/or a hydrocarbyl group); an amido radical which is unsubstituted or substituted by up to two C₁₋₈ alkyl radicals; a phosphido radical which is unsubstituted or substituted by up to two C₁₋₈ alkyl radicals; a silyl radical of the formula —Si(R′)₃ wherein each R′ is independently selected from the group consisting of hydrogen, a C₁₋₈ alkyl or alkoxy radical, C₆₋₁₀ aryl or aryloxy radicals; and a germanyl radical of the formula —Ge(R′)₃ wherein R′ is as defined directly above.

The phosphinimine ligand, PI, is defined by formula:

(R^{p})₃P═N—

wherein the R^{p} groups are independently selected from: a hydrogen atom; a halogen atom; C₁₋₂₀ hydrocarbyl radicals which are unsubstituted or substituted with one or more halogen atom(s); a C₁₋₈ alkoxy radical; a C₆₋₁₀ aryl radical; a C₆₋₁₀ aryloxy radical; an amido radical; a silyl radical of formula —Si(R^{s})₃, wherein the R$ groups are independently selected from, a hydrogen atom, a C₁₋₈ alkyl or alkoxy radical, a C₆₋₁₀ aryl radical, a C₆₋₁₀ aryloxy radical, or a germanyl radical of formula —Ge(R^{G})₃, wherein the R^{G} groups are defined as R$ is defined in this paragraph.

In an embodiment of the disclosure, the metal, M in the phosphinimine catalyst is titanium, Ti.

In an embodiment of the disclosure, the single site catalyst used to make the second ethylene copolymer is cyclopentadienyl tri(tertiarybutyl)phosphinimine titanium dichloride, Cp((t-Bu)₃PN)TiCl₂.

As already discussed above, in addition to the single site catalyst molecule per se, an active single site catalyst system may further comprise one or more of the following: an alkylaluminoxane co-catalyst and an ionic activator, both of which have already been defined above. The single site catalyst system may also optionally comprise a hindered phenol, as already defined above.

To produce an active single site catalyst system the quantity and mole ratios of the three or four components: the single site catalyst moleculare (e.g. the phosphinimine single site catalyst molecule), the alkylaluminoxane, the ionic activator, and the optional hindered phenol may be optimized.

In an embodiment of the disclosure, the single site catalyst used to make the second ethylene copolymer produces no long chain branches, and/or the second copolymer will contain no measurable amounts of long chain branches.

In an embodiment of the disclosure, the second ethylene copolymer is made with a multi-site catalyst system, non-limiting examples of which include Ziegler-Natta catalysts and chromium catalysts, both of which are well known in the art.

In an embodiment of the disclosure, the second ethylene copolymer is made with a Ziegler-Natta catalyst system.

In an embodiment of the disclosure, the second ethylene copolymer is made with a Ziegler-Natta catalyst system in a solution phase polymerization process.

Ziegler-Natta catalyst systems are well known to those skilled in the art. A Ziegler-Natta catalyst may be an in-line Ziegler-Natta catalyst system or a batch Ziegler-Natta catalyst system. The term “in-line Ziegler-Natta catalyst system” refers to the continuous synthesis of a small quantity of an active Ziegler-Natta catalyst system and immediately injecting this catalyst into at least one continuously operating reactor, wherein the catalyst polymerizes ethylene and one or more optional α-olefins to form an ethylene polymer. The terms “batch Ziegler-Natta catalyst system” or “batch Ziegler-Natta procatalyst” refer to the synthesis of a much larger quantity of catalyst or procatalyst in one or more mixing vessels that are external to, or isolated from, the continuously operating solution polymerization process. Once prepared, the batch Ziegler-Natta catalyst system, or batch Ziegler-Natta procatalyst, is transferred to a catalyst storage tank. The term “procatalyst” refers to an inactive catalyst system (inactive with respect to ethylene polymerization); the procatalyst is converted into an active catalyst by adding an alkyl aluminum co-catalyst. As needed, the procatalyst is pumped from the storage tank to at least one continuously operating reactor, wherein an active catalyst polymerizes ethylene and one or more optional α-olefins to form a cthylene copolymer. The procatalyst may be converted into an active catalyst in the reactor or external to the reactor, or on route to the reactor.

A wide variety of compounds can be used to synthesize an active Ziegler-Natta catalyst system. The following describes various compounds that may be combined to produce an active Ziegler-Natta catalyst system. Those skilled in the art will understand that the embodiments in this disclosure are not limited to the specific compounds disclosed.

An active Ziegler-Natta catalyst system may be formed from: a magnesium compound, a chloride compound, a metal compound, an alkyl aluminum co-catalyst and an aluminum alkyl. As will be appreciated by those skilled in the art, Ziegler-Natta catalyst systems may contain additional components; a non-limiting example of an additional component is an electron donor, e.g. amines or ethers.

A non-limiting example of an active in-line (or batch) Ziegler-Natta catalyst system can be prepared as follows. In the first step, a solution of a magnesium compound is reacted with a solution of a chloride compound to form a magnesium chloride support suspended in solution. Non-limiting examples of magnesium compounds include Mg(R¹)₂; wherein the R¹ groups may be the same or different, linear, branched or cyclic hydrocarbyl radicals containing 1 to 10 carbon atoms. Non-limiting examples of chloride compounds include R²Cl; wherein R² represents a hydrogen atom, or a linear, branched or cyclic hydrocarbyl radical containing 1 to 10 carbon atoms. In the first step, the solution of magnesium compound may also contain an aluminum alkyl compound. Non-limiting examples of aluminum alkyl compounds include Al(R³)₃, wherein the R³ groups may be the same or different, linear, branched or cyclic hydrocarbyl radicals containing from 1 to 10 carbon atoms. In the second step a solution of the metal compound is added to the solution of magnesium chloride and the metal compound is supported on the magnesium chloride. Non-limiting examples of suitable metal compounds include M(X)ₙ or MO(X)ₙ; where M represents a metal selected from Group 4 through Group 8 of the Periodic Table, or mixtures of metals selected from Group 4 through Group 8; O represents oxygen; X represents chloride or bromide; and n is an integer from 3 to 6 that satisfies the oxidation state of the metal. Additional non-limiting examples of suitable metal compounds include Group 4 to Group 8 metal alkyls, metal alkoxides (which may be prepared by reacting a metal alkyl with an alcohol) and mixed-ligand metal compounds that contain a mixture of halide, alkyl and alkoxide ligands. In an embodiment of the disclosure, a suitable metal compound is titanium tetrachloride, TiCl₄. In the third step a solution of an alkyl aluminum co-catalyst is added to the metal compound supported on the magnesium chloride. A wide variety of alkyl aluminum co-catalysts are suitable, as expressed by formula:

Al(R⁴)ₚ(OR⁹)_{q}(X)ᵣ

wherein the R⁴ groups may be the same or different, hydrocarbyl groups having from 1 to 10 carbon atoms; the OR⁹ groups may be the same or different, alkoxy or aryloxy groups wherein R⁹ is a hydrocarbyl group having from 1 to 10 carbon atoms bonded to oxygen; X is chloride or bromide; and (p+q+r)=3, with the proviso that p is greater than 0. Non-limiting examples of commonly used alkyl aluminum co-catalysts include trimethyl aluminum, triethyl aluminum, tributyl aluminum, dimethyl aluminum methoxide, diethyl aluminum ethoxide, dibutyl aluminum butoxide, dimethyl aluminum chloride or bromide, diethyl aluminum chloride or bromide, dibutyl aluminum chloride or bromide and ethyl aluminum dichloride or dibromide.

The process described in the paragraph above, to synthesize an active in-line (or batch) Ziegler-Natta catalyst system, can be carried out in a variety of solvents; non-limiting examples of solvents include linear or branched C₅ to C₁₂ alkanes or mixtures thereof.

The second ethylene copolymer may contain catalyst residues that reflect the chemical composition of the catalyst formulation used to make it. Those skilled in the art will understand that catalyst residues are typically quantified by the parts per million of metal, in for example the second ethylene copolymer (or the polyethylene composition; see below), where the metal present originates from the metal in the catalyst formulation used to make it. Non-limiting examples of the metal residue which may be present include Group 4 metals, titanium, zirconium and hafnium. In embodiments of the disclosure, the upper limit on the ppm of metal in the second ethylene copolymer may be about 3.0 ppm, in other cases about 2.0 ppm and in still other cases about 1.5 ppm. In embodiments of the disclosure, the lower limit on the ppm of metal in the second ethylene copolymer may be about 0.03 ppm, in other cases about 0.09 ppm and in still other cases about 0.15 ppm.

In an embodiment of the disclosure, the short chain branching in the second ethylene copolymer can be from about 0.05 to about 5.0 short chain branches per thousand carbon atoms (SCB2/1000 Cs). In further embodiments of the disclosure, the short chain branching in the second ethylene copolymer can be from 0.10 to 3.0, or from 0.10 to 2.5, or from 0.10 to 2.0, or from 0.10 to 1.5, or from 0.10 to 1.0, or from 0.10 to 0.50, or from 0.05 to 3.0, or from 0.05 to 2.5, or from 0.05 to 2.0, or from 0.05 to 1.5, or from 0.05 to 1.0, or from 0.05 to 0.50 short chain branches per thousand carbon atoms (SCB2/1000 Cs).

The short chain branching (i.e. the short chain branching per thousand backbone carbon atoms, SCB2) is the branching due to the presence of an α-olefin comonomer in the ethylene copolymer and will for example have two carbon atoms for a 1-butene comonomer, or four carbon atoms for a 1-hexene comonomer, or six carbon atoms for a 1-octene comonomer, etc.

In an embodiment of the disclosure, the number of short chain branches per thousand carbon atoms in the second ethylene copolymer (SCB2), is fewer than the number of short chain branches per thousand carbon atoms in the first ethylene copolymer (SCB1). In an embodiment of the disclosure, the density of the second copolymer is greater than the density of the first ethylene copolymer.

In embodiments of the disclosure, the second ethylene copolymer has a density of from 0.945 to 0.975 g/cm³, including any narrower ranges within this range and any values encompassed by these ranges. For example, in embodiments of the disclosure, the second ethylene copolymer has a density of from 0.945 to 0.970 g/cm³, or from 0.945 to 0.967 g/cm³, or from 0.950 to 0.970 g/cm³, or from 0.950 to 0.967 g/cm³, or from 0.955 to 0.970 g/cm³, or from 0.955 to 0.967 g/cm³, or from 0.960 to 0.970 g/cm³, or from 0.960 to 0.967 g/cm³.

In an embodiment of the disclosure, the melt index, I₂ of the second ethylene copolymer is greater than the melt index, I₂ of first ethylene copolymer.

In embodiments of the disclosure the second ethylene copolymer has a melt index, I₂ of ≥10.0 g/10 min, or >10.0 g/10 min, or ≥20.0 g/10 min, or >20 g/10 min.

In embodiments of the disclosure the second ethylene copolymer has a melt index, I₂ of from 10 to 1,000 including any narrower ranges within this range and any values encompassed by these ranges. For example, in embodiments of the disclosure, the melt index, I₂ of the second ethylene copolymer is from 10 to 500 g/10 min, or from 10 to 250 g/10 min, or from 10 to 150 g/10 min, or from 20 to 500 g/10 min, or from 20 to 250 g/10 min, or from 20 to 150 g/10 min, or from 10 to 100 g/10 min, or from 20 to 100 g/10 min.

In an embodiment of the disclosure, the second ethylene copolymer has a weight average molecular weight, M_{w} of ≤75,000 g/mol, or ≤60,000 g/mol, or ≤50,000 g/mol, or ≤45,000 g/mol.

In embodiments of the disclosure, the second ethylene copolymer has a weight average molecular weight, M_{w} of from 5,000 to 75,000 g/mol, including any narrower ranges within this range and any values encompassed by these ranges. For example, in embodiments of the disclosure, the second ethylene copolymer has a weight average molecular weight, M_{w} of from 10,000 to 75,000 g/mol, or from 15,000 to 75,000 g/mol, or from 15,000 to 65,000 g/mol, or from 15,000 to 60,000 g/mol, or from 15,000 to 50,000 g/mol, or from 20,000 to 60,000 g/mol, or from 20,000 to 55,000 g/mol, or from 20,000 to 50,000 g/mol, or from 20,000 to 45,000 g/mol.

In an embodiment of the disclosure, the second ethylene copolymer has a melt flow ratio, I₂₁/I₂ of less than 25, or less than 23, or less than 20.

In embodiments of the disclosure, the upper limit on the molecular weight distribution, M_{w}/Mₙ of the second ethylene copolymer may be about 2.7, or about 2.5, or about 2.4, or about 2.3, or about 2.2. In embodiments of the disclosure, the lower limit on the molecular weight distribution, M_{w}/Mₙ of the second ethylene copolymer may be about 1.6, or about 1.7, or about 1.8, or about 1.9.

In embodiments of the disclosure, the second ethylene copolymer has a molecular weight distribution, M_{w}/Mₙ of ≤3.0, or <3.0, or ≤2.7, or <2.7, or ≤2.5, or <2.5, or ≤2.3, or <2.3, or ≤2.1, or <2.1, or about 2. In another embodiment of the disclosure, the second ethylene copolymer has a molecular weight distribution, M_{w}/Mₙ of from 1.7 to 3.0, including any narrower ranges within this range and any values encompassed by these ranges. For example, in embodiments of the disclosure, the second ethylene copolymer has a molecular weight distribution, M_{w}/Mₙ of from 1.8 to 2.7, or from 1.8 to 2.5, or from 1.8 to 2.3, or from 1.7 to 2.3, or from 1.9 to 2.1, or about 2.0.

In embodiments of the disclosure, the second ethylene copolymer has a molecular weight distribution, M_{w}/Mₙ of ≥2.3, or >2.3, or ≥2.5, or >2.5, or ≥2.7, or >2.7, or ≥2.9, or >2.9, or ≥3.0, or 3.0. In embodiments of the disclosure, the second ethylene copolymer has a molecular weight distribution, M_{w}/Mₙ of from 2.3 to 6.0, or from 2.3 to 5.5, or from 2.3 to 5.0, or from 2.3 to 4.5, or from 2.3 to 4.0, or from 2.3 to 3.5, or from 2.3 to 3.0, or from 2.5 to 5.0, or from 2.5 to 4.5, or from 2.5 to 4.0, or from 2.5 to 3.5, or from 2.7 to 5.0, or from 2.7 to 4.5, or from 2.7 to 4.0, or from 2.7 to 3.5.

In an embodiment of the disclosure, a single site catalyst which gives an ethylene copolymer having a CDBI₅₀ of at least 60% by weight, or at least 65 wt %, or at least 70 wt %, or at least 75 wt %, or at least 80 wt %, or at least 85 wt %, during solution phase polymerization in a single reactor, is used in the preparation of the second ethylene copolymer.

In an embodiment of the disclosure, a multi-site catalyst which gives an ethylene copolymer having a CDBI₅₀ of at less than 60% by weight, or less than 50 wt %, during solution phase polymerization in a single reactor, is used in the preparation of the second ethylene copolymer.

In embodiments of the disclosure, the weight percent (wt %) of the second ethylene copolymer in the polyethylene composition (i.e. the weight percent of the second ethylene copolymer based on the total weight of the first ethylene copolymer and the second ethylene copolymers) may be from about 95 wt % to about 40 wt %, including any narrower ranges within this range and any values encompassed by these ranges. For example, in embodiments of the disclosure, the weight percent (wt %) of the second ethylene copolymer in the polyethylene copolymer composition may be from about 95 wt % to about 50 wt %, or from about 90 wt % to about 40 wt %, or from about 85 wt % to about 50 wt %, or from about 90 wt % to about 60 wt %, or from about 85 wt % to about 60 wt % or from about 85 wt % to about 65 wt %.

### The Polyethylene Composition

In an embodiment of the disclosure, the polyethylene composition will comprise a first ethylene copolymer and a second ethylene copolymer (each as defined above).

The polyethylene compositions disclosed herein can be made using any well-known techniques in the art, including but not limited to melt blending, solution blending, or in-reactor blending to bring together a first ethylene copolymer and a second ethylene copolymer.

In an embodiment, the polyethylene composition of the present disclosure is made using a single site catalyst in a first reactor to give a first ethylene copolymer, and a single site catalyst in a second reactor to give a second ethylene copolymer.

In an embodiment, the polyethylene composition of the present disclosure is made using a single site catalyst in a first reactor to give a first ethylene copolymer, and a multi-site catalyst in a second reactor to give a second ethylene copolymer.

In an embodiment, the polyethylene composition of the present disclosure is made by forming a first ethylene copolymer in a first reactor by polymerizing ethylene and an α-olefin with a single site catalyst; and forming a second ethylene copolymer in a second reactor by polymerizing ethylene and an α-olefin with a single site catalyst.

In an embodiment, the polyethylene composition of the present disclosure is made by forming a first ethylene copolymer in a first reactor by polymerizing ethylene and an α-olefin with a single site catalyst; and forming a second ethylene copolymer in a second reactor by polymerizing ethylene and an α-olefin with a multi-site catalyst.

In an embodiment, the polyethylene composition of the present disclosure is made by forming a first ethylene copolymer in a first solution phase polymerization reactor by polymerizing ethylene and an α-olefin with a single site catalyst; and forming a second ethylene copolymer in a second solution phase polymerization reactor by polymerizing ethylene and an α-olefin with a single site catalyst.

In an embodiment, the polyethylene composition of the present disclosure is made by forming a first ethylene copolymer in a first solution phase polymerization reactor by polymerizing ethylene and an α-olefin with a single site catalyst; and forming a second ethylene copolymer in a second solution phase polymerization reactor by polymerizing ethylene and an α-olefin with a multi-site catalyst.

In an embodiment, the polyethylene composition of the present disclosure is made by forming a first ethylene copolymer in a first solution phase polymerization reactor by polymerizing ethylene and α-olefin with a single site catalyst; and forming a second ethylene copolymer in a second solution phase polymerization reactor by polymerizing ethylene and an α-olefin with a single site catalyst, where the first and second solution phase polymerization reactors are configured in series with one another.

In an embodiment, the polyethylene composition of the present disclosure is made by forming a first ethylene copolymer in a first solution phase polymerization reactor by polymerizing ethylene and α-olefin with a single site catalyst; and forming a second ethylene copolymer in a second solution phase polymerization reactor by polymerizing ethylene and an α-olefin with a multi-site catalyst, where the first and second solution phase polymerization reactors are configured in series with one another.

In an embodiment, the polyethylene composition of the present disclosure is made by forming a first ethylene copolymer in a first solution phase polymerization reactor by polymerizing ethylene and α-olefin with a single site catalyst; and forming a second ethylene copolymer in a second solution phase polymerization reactor by polymerizing ethylene and an α-olefin with a single site catalyst, where the first and second solution phase polymerization reactors are configured in parallel to one another.

In an embodiment, the polyethylene composition of the present disclosure is made by forming a first ethylene copolymer in a first solution phase polymerization reactor by polymerizing ethylene and α-olefin with a single site catalyst; and forming a second ethylene copolymer in a second solution phase polymerization reactor by polymerizing ethylene and an α-olefin with a multi-site catalyst, where the first and second solution phase polymerization reactors are configured in parallel to one another.

In embodiments, the solution phase polymerization reactor used as a first solution phase reactor is a continuously stirred tank reactor or a tubular reactor.

In an embodiment, the solution phase polymerization reactor used as a second solution phase reactor is a continuously stirred tank reactor or a tubular reactor.

In solution polymerization, the monomers are dissolved/dispersed in the solvent either prior to being fed to the reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g. molecular sieves, alumina beds and oxygen removal catalysts are used for the purification of monomers. The solvent itself as well (e.g. methyl pentane, cyclohexane, hexane or toluene) is preferably treated in a similar manner.

The feedstock may be heated or cooled prior to feeding to the reactor.

Generally, the catalyst components may be premixed in the solvent for the reaction or fed as separate streams to the reactor. In some instances, catalyst components premixing may be desirable to provide a reaction time for the catalyst components prior to entering the polymerization reaction zone. Such an “in line mixing” technique is well known to persons skilled in the art.

Solution polymerization processes for the polymerization or copolymerization of ethylene are well known in the art (see for example, U.S. Pat. Nos. 6,372,864 and 6,777,509). These processes are conducted in the presence of an inert hydrocarbon solvent. In a solution phase polymerization reactor, a variety of solvents may be used as the process solvent; non-limiting examples include linear, branched or cyclic C₅ to C₁₂ alkanes. Suitable catalyst component solvents include aliphatic and aromatic hydrocarbons. Non-limiting examples of aliphatic catalyst component solvents include linear, branched or cyclic C₅₋₁₂ aliphatic hydrocarbons, e.g. pentane, methyl pentane, hexane, heptane, octane, cyclohexane, cyclopentane, methylcyclohexane, hydrogenated naphtha or combinations thereof. Non-limiting examples of aromatic catalyst component solvents include benzene, toluene (methylbenzene), ethylbenzene, o-xylene (1,2-dimethylbenzene), m-xylene (1,3-dimethylbenzene), p-xylene (1,4-dimethylbenzene), mixtures of xylene isomers, hemellitene (1,2,3-trimethylbenzene), pseudocumene (1,2,4-trimethylbenzene), mesitylene (1,3,5-trimethylbenzene), mixtures of trimethylbenzene isomers, prehenitene (1,2,3,4-tetramethylbenzene), durene (1,2,3,5-tetramethylbenzene), mixtures of tetramethylbenzene isomers, pentamethylbenzene, hexamethylbenzene and combinations thereof.

In embodiments of the disclosure, the polymerization temperature in a conventional solution process may be from about 80° C. to about 300° C. In an embodiment of the disclosure the polymerization temperature in a solution process is from about 120° C. to about 250° C.

In embodiments of the disclosure, the polymerization pressure in a solution process may be a “medium pressure process”, meaning that the pressure in the reactor is less than about 6,000 psi (about 42,000 kiloPascals or kPa). In embodiments of the disclosure, the polymerization pressure in a solution process may be from about 10,000 to about 40,000 kPa, or from about 14,000 to about 22,000 kPa (i.e. from about 2,000 psi to about 3,000 psi).

In embodiments of the disclosure, suitable comonomers (i.e. α-olefins) for copolymerization with ethylene in a solution phase polymerization process include C₃₋₂₀ mono- and di-olefins. In embodiments of the disclosure, comonomers which may be copolymerized with ethylene include C₃₋₁₂ α-olefins which are unsubstituted or substituted by up to two C₁₋₆ alkyl radicals, C₈₋₁₂ vinyl aromatic monomers which are unsubstituted or substituted by up to two substituents selected from the group consisting of C₁₋₄ alkyl radicals, C₄₋₁₂ straight chained or cyclic diolefins which are unsubstituted or substituted by a C₁₋₄ alkyl radical. In further embodiments of the disclosure, α-olefins which may be copolymerized with ethylene are one or more of propylene, 1-butene, 1-pentene, 1-hexene, 1-octene and 1-decene, styrene, alpha methyl styrene, and the constrained-ring cyclic olefins such as cyclobutene, cyclopentene, dicyclopentadiene norbornene, alkyl-substituted norbornenes, alkenyl-substituted norbornenes and the like (e.g. 5-methylene-2-norbornene and 5-ethylidene-2-norbornene, bicyclo-(2,2,1)-hepta-2,5-diene).

In an embodiment of the disclosure, the polyethylene composition comprises ethylene and one or more than one alpha olefin selected from the group comprising 1-butene, 1-hexene, 1-octene and mixtures thereof.

In an embodiment of the disclosure, the polyethylene composition comprises ethylene and one or more than one alpha olefin selected from the group comprising 1-hexene, 1-octene and mixtures thereof.

In an embodiment of the disclosure, the polyethylene composition comprises ethylene and 1-octene.

In embodiments of the disclosure, the polyethylene composition has from 0.01 to 5 mole percent of one or more than one α-olefin, including any narrower ranges within this range and any values encompassed by these ranges. For example, in embodiments of the disclosure, the polyethylene composition has from 0.05 to 5.0 mole percent of one or more than one α-olefin, or from 0.05 to 2.5 mole percent of one or more than one α-olefin, or from 0.05 to 1.5 mole percent of one or more than one α-olefin, or from 0.05 to 1.0 mole percent of one or more than one α-olefin, or from 0.1 to 2.5 mole percent of one or more than one α-olefin, or from 0.1 to 1.5 mole percent of one or more than one α-olefin, or from 0.1 to 1.0 mole percent of one or more than one α-olefin.

In embodiments of the disclosure, the polyethylene composition has from 0.05 to 5.0 mole percent of 1-octene, or from 0.05 to 2.5 mole percent of 1-octene, or from 0.05 to 1.5 mole percent of 1-octene, or from 0.05 to 1.0 mole percent of 1-octene, or from 0.1 to 2.5 mole percent of 1-octene, or from 0.1 to 1.5 mole percent of 1-octene, or from 0.10 to 1.0 mole percent of 1-octene.

In an embodiment of the disclosure, the polyethylene composition that comprises a first ethylene copolymer and a second ethylene copolymer (as defined above) will have a ratio (SCB1/SCB2) of the number of short chain branches per thousand carbon atoms in the first ethylene copolymer (i.e., SCB1) to the number of short chain branches per thousand carbon atoms in the second ethylene copolymer (i.e., SCB2) of at least 5.0 (i.e., SCB1/SCB2≥5.0). In further embodiments of the disclosure, the ratio of the short chain branching in the first ethylene copolymer (SCB1) to the short chain branching in the second ethylene copolymer (SCB2) is at least 7.5 or greater than 7.5. In still further embodiments of the disclosure, the ratio of the short chain branching in the first ethylene copolymer (SCB1) to the short chain branching in the second ethylene copolymer (SCB2) is at least 10.0 or greater than 10.0.

In embodiments of the disclosure, the polyethylene composition has a weight average molecular weight, M_{w} of from 65,000 to 250,000 g/mol, including any narrower ranges within this range and any values encompassed by these ranges. For example, in embodiments of the disclosure, the polyethylene composition has a weight average molecular weight, M_{w} of from 75,000 to 200,000 g/mol, or from 65,000 to 175,000 g/mol, or from 75,000 to 150,000 g/mol, or from 65,000 to 150,000 g/mol, or from 75,000 to 125,000 g/mol, or from 65,000 to 125,000 g/mol, or from 85,000 to 125,000 g/mol, or from 90,000 to 125,000 g/mol.

In an embodiment of the disclosure, the polyethylene composition has a number average molecular weight, Mₙ of ≤60,000 g/mol, or ≤50,000 g/mol, or <50,000 g/mol, or ≤45,000 g/mol, or <45,000 g/mol, or ≤40,000 g/mol, or <40,000 g/mol, or ≤35,000 g/mol, or <35,000 g/mol, or ≤30,000 g/mol, or <30,000 g/mol, or ≤25,000 g/mol, or <25,000 g/mol. In further embodiments of the disclosure, the polyethylene composition has a number average molecular weight, Mₙ of from 5,000 to 60,000 g/mol, including any narrower ranges within this range and any values encompassed by these ranges. For example, in embodiments of the disclosure, the polyethylene composition has a number average molecular weight, Mₙ of from 10,000 to 55,000 g/mol, or from 10,000 to 50,000 g/mol, or from 15,000 to 50,000 g/mol, or from 15,000 to 45,000 g/mol, or from 15,000 to 40,000 g/mol, or from 15,000 to 35,000 g/mol, or from 15,000 to 30,000 g/mol, or from 15,000 to 25,000 g/mol.

In an embodiment of the disclosure, the polyethylene composition has a Z-average molecular weight, M_{z}, of ≥250,000 g/mol, or ≥275,000 g/mol, ≥300,000 g/mol.

In further embodiments of the disclosure, the polyethylene composition has a Z-average molecular weight, M_{z} of from 250,000 to 600,000 g/mol, including any narrower ranges within this range and any values encompassed by these ranges. For example, in embodiments of the disclosure, the polyethylene composition has a Z-average molecular weight, M_{z} of from 250,000 to 550,000 g/mol, or from 275,000 to 500,000 g/mol, or from 275,000 to 475,000 g/mol, or from 275,000 g/mol to 450,000 g/mol, or from 300,000 to 475,000 g/mol, or from 300,000 g/mol to 450,000 g/mol.

In an embodiment of the disclosure, the polyethylene copolymer composition has a bimodal profile (i.e. a bimodal molecular weight distribution) in a gel permeation chromatography (GPC) analysis.

In an embodiment of the disclosure, the polyethylene copolymer composition has a bimodal profile in a gel permeation chromatograph generated according to the method of ASTM D6474-99.

The term “unimodal” is herein defined to mean there will be only one significant peak or maximum evident in the GPC-curve. In contrast, the use of the term “bimodal” is meant to convey that in addition to a first peak, there will be a secondary peak or shoulder which represents a higher or lower molecular weight component (i.e. the molecular weight distribution, can be said to have two maxima in a molecular weight distribution curve). Alternatively, the term “bimodal” connotes the presence of two maxima in a molecular weight distribution curve generated according to the method of ASTM D6474-99. The term “multi-modal” denotes the presence of two or more, typically more than two, maxima in a molecular weight distribution curve generated according to the method of ASTM D6474-99.

In embodiments of the disclosure, the polyethylene composition has a molecular weight distribution, M_{w}/Mₙ of ≤7.0, or <7.0, or ≤6.5, or <6.5, or ≤6.0, or <6.0, or 5.5, or <5.5, or ≤5.0, or <5.0. In further embodiments of the disclosure, the polyethylene composition has a molecular weight distribution, M_{w}/Mₙ of from 2.9 to 7.5, including any narrower ranges within this range and any values encompassed by these ranges. For example, in embodiments of the disclosure, the polyethylene composition has a molecular weight distribution, M_{w}/Mₙ of from 3.0 to 7.0, or from 3.0 to 6.5, or from 3.0 to 6.0, or from 3.5 to 7.0, or from 3.5 to 6.5, or from 3.5 to 6.0, or from 4.0 to 7.0, or from 4.0 to 6.5, or from 4.0 to 6.0.

In embodiments of the disclosure, the polyethylene composition has a Z-average molecular weight distribution, M_{z}/M_{w} of >2.5, or >2.6, or >2.7, or >2.8, or >2.9, or >3.0.

In embodiments of the disclosure, the polyethylene composition has a Z-average molecular weight distribution, M_{z}/M_{w} of from 2.5 to 5.0 including any narrower ranges within this range and any values encompassed by these ranges. For example, in embodiments of the disclosure, the polyethylene composition has a Z-average molecular weight distribution, M_{z}/M_{w} of from 2.7 to 4.5, or from 2.8 to 4.5, or from 3.0 to 4.5, or from 3.0 to 5.0.

In embodiments of the disclosure, the polyethylene copolymer composition has a density of ≥0.945 g/cm³, or ≥0.948 g/cm³, or ≥0.949 g/cm³, or ≥0.950 g/cm³.

In embodiments of the disclosure, the polyethylene composition has a density of from 0.945 to 0.970 g/cm³, including any narrower ranges within this range and any values encompassed by these ranges. For example, in embodiments of the disclosure, the polyethylene composition has a density of from 0.948 to 0.970 g/cm³, or from 0.949 to 0.970 g/cm³, or from 0.950 to 0.970 g/cm³, or from 0.945 to 0.965 g/cm³, or from 0.948 to 0.965 g/cm³, or from 0.949 to 0.965 g/cm³, or from 0.950 to 0.965 g/cm³, or from 0.945 to 0.960 g/cm³, or from 0.948 to 0.960 g/cm³, or from 0.949 to 0.960 g/cm³, or from 0.950 to 0.960 g/cm³, or from 0.948 to 0.957 g/cm³, or from 0.949 to 0.957 g/cm³.

In embodiments of the disclosure, the polyethylene composition has a melt index, I₂ of from 0.001 to 5.0 g/10 min, including any narrower ranges within this range and any values encompassed by these ranges. For example, in embodiments of the disclosure, the melt index, I₂ of the polyethylene composition may be from 0.01 to 5.0 g/10 min, or from 0.1 to 5.0 g/10 min, or from 0.01 to 4.0 g/10 min, or from 0.1 to 4.0 g/10 min 0.01 to 2.5 g/10 min, or from 0.1 to 2.5 g/10 min, or from 0.5 to 5.0 g/10 min, or 0.8 to 5.0 g/10 min, or from 0.5 to 4.0 g/10 min, or from 0.8 to 4.0 g/10 min, or from 0.8 to 2.5 g/10 min, or from 1.0 to 5.0 g/10 min, or from 1.0 to 4.0 g/10 min, or from 1.0 to 2.5 g/10 min.

In embodiments of the disclosure the polyethylene composition has a high load melt index, 121 of at least 65 g/10 min, or at least 70 g/10 min, or at least 80 g/10 min, or at least 90 g/10 min. In further embodiments of the disclosure, the polyethylene composition has a high load melt index, I₂₁ of from 60 to 160 g/10 min, including any narrower ranges within this range and any values encompassed by these ranges. For example, in embodiments of the disclosure, the high load melt index, 121 of the polyethylene composition may be from 65 to 160 g/10 min, or from 70 to 160 g/10 min, from 60 to 150 g/10 min, or from 65 to 150 g/10 min, or from 70 to 150 g/10 min, or from 80 to 150 g/10 min, or from 90 to 150 g/10 min, or from 60 to 130 g/10 min, or from 60 to 120 g/10 min, or from 70 to 130 g/10 min.

In embodiments of the disclosure the polyethylene composition has a melt flow ratio, I₂₁/I₂ of ≥50, or >50, or ≥55, or >55, or ≥60, or >60. In further embodiments of the disclosure the polyethylene composition has a melt flow ratio, I₂₁/I₂ of from 50 to 140, including any narrower ranges within this range and any values encompassed by these ranges. For example, in embodiments of the disclosure, the polyethylene composition has a melt flow ratio, I₂₁/I₂ of from 50 to 130, or from 50 to 120, or from 50 to 110, or from 60 to 130, or from 60 to 120.

In an embodiment of the disclosure, the polyethylene composition will have a reverse or partially reverse comonomer distribution profile as measured using GPC-FTIR. If the comonomer incorporation decreases with molecular weight, as measured using GPC-FTIR, the distribution is described as “normal”. If the comonomer incorporation is approximately constant with molecular weight, as measured using GPC-FTIR, the comonomer distribution is described as “flat” or “uniform”. The terms “reverse comonomer distribution” and “partially reverse comonomer distribution” mean that in the GPC-FTIR data obtained for a copolymer, there is one or more higher molecular weight components having a higher comonomer incorporation than in one or more lower molecular weight components. The term “reverse(d) comonomer distribution” is used herein to mean, that across the molecular weight range of an ethylene copolymer, comonomer contents for the various polymer fractions are not substantially uniform and the higher molecular weight fractions thereof have proportionally higher comonomer contents (i.e. if the comonomer incorporation rises with molecular weight, the distribution is described as “reverse” or “reversed”). Where the comonomer incorporation rises with increasing molecular weight and then declines, the comonomer distribution is still considered “reverse”, but may also be described as “partially reverse”. A partially reverse comonomer distribution will exhibit a peak or maximum.

In an embodiment of the disclosure the polyethylene composition has a reversed comonomer distribution profile as measured using GPC-FTIR.

In an embodiment of the disclosure the polyethylene composition has a partially reversed comonomer distribution profile as measured using GPC-FTIR.

In embodiments of the disclosure, the CDBI₅₀ of the polyethylene composition will be greater than 60 weight %, or greater than 70 wt %, or greater than 80 wt %. In embodiments of the disclosure, the CDBI₅₀ of the polyethylene composition will be from 60 to 98 weight %, or from 70 to 90 wt %, or from 80 to 90 wt %.

In embodiments of the disclosure, the CDBI₅₀ of the polyethylene composition will be less than 60 weight %, or less than 50 wt %. In embodiments of the disclosure, the CDBI₅₀ of the polyethylene composition will be from 30 to 55 weight %, or from 30 to 50 wt %, or from 35 to 55 wt %, or from 35 to 50 wt %.

In embodiments of the disclosure, the upper limit on the parts per million (ppm) of hafnium in the polyethylene composition (ppm of hafnium metal, based on the weight of the polyethylene composition) may be about 3.0 ppm, or about 2.5 ppm, or about 2.4 ppm, or about 2.0 ppm, or about 1.5 ppm, or about 1.0 ppm, or about 0.75 ppm, or about 0.5 ppm. In embodiments of the disclosure, the lower limit on the parts per million (ppm) of hafnium in the polyethylene composition (ppm of hafnium metal, based on the weight of the polyethylene composition) may be about 0.0015 ppm, or about 0.0050 ppm, or about 0.0075 ppm, or about 0.010 ppm, or about 0.015 ppm, or about 0.030 ppm, or about 0.050 ppm, or about 0.075 ppm, or about 0.100 ppm, or about 0.150 ppm, or about 0.175 ppm, or about 0.200 ppm.

In embodiments of the disclosure, the polyethylene composition has from 0.0015 to 2.4 ppm of hafnium, or from 0.0050 to 2.4 ppm of hafnium, or from 0.0075 to 2.4 ppm of hafnium, or from 0.010 to 2.4 ppm of hafnium, or from 0.015 to 2.4 ppm of hafnium, or from 0.050 to 3.0 ppm of hafnium, or from 0.050 to 2.4 ppm, or from 0.050 to 2.0 ppm, or from 0.050 to 1.5 ppm, or from 0.050 to 1.0 ppm, or from 0.050 to 0.75 ppm, or from 0.075 to 2.4 ppm of hafnium, or from 0.075 to 2.0 ppm of hafnium, or from 0.075 to 1.5 ppm of hafnium, or from 0.075 to 1.0 ppm of hafnium, or from 0.075 to 0.75 ppm of hafnium, or from 0.100 to 2.0 ppm of hafnium, or from 0.100 to 1.5 ppm of hafnium, or from 0.100 to 1.0 ppm of hafnium, or from 0.100 to 0.75 ppm of hafnium.

In embodiments of the disclosure, the polyethylene composition has at least 0.0015 ppm of hafnium, or at least 0.005 ppm of hafnium, or at least 0.0075 ppm of hafnium, or at least 0.015 ppm of hafnium, or at least 0.030 ppm of hafnium, or at least 0.050 ppm of hafnium, or at least 0.075 ppm of hafnium, or at least 0.100 ppm of hafnium, or at least 0.125 ppm of hafnium, or at least 0.150 ppm of hafnium, or at least 0.175 ppm of hafnium, or at least 0.200 ppm of hafnium, or at least 0.300 ppm of hafnium, or at least 0.350 ppm of hafnium.

In embodiments of the disclosure, the polyethylene composition has fewer than 5.0 ppm of titanium (ppm of titanium metal, based on the weight of the polyethylene composition), or fewer than 4.0 ppm of titanium, or fewer than 3.0 ppm of titanium, or fewer than 3.0 ppm of titanium, or fewer than 2.0 ppm of titanium, or fewer than 1.0 ppm of titanium, or fewer than 0.5 ppm of titanium, or fewer than 0.3 ppm of titanium.

In embodiments of the disclosure, the polyethylene composition has fewer than 25.0 ppm of aluminum (ppm of aluminum metal, based on the weight of the polyethylene composition), or fewer than 20.0 ppm of aluminum, or fewer than 15.0 ppm of aluminum, or fewer than 10.0 ppm of aluminum.

In embodiments of the disclosure, the polyethylene composition has fewer than 15.0 ppm of magnesium (ppm of magnesium metal, based on the weight of the polyethylene composition), or fewer than 10.0 ppm of magnesium, or fewer than 5.0 ppm of magnesium, or fewer than 1 ppm of magnesium.

In an embodiment of the disclosure, the polyethylene composition contains long chain branching characterized by the long chain branching factor, LCBF disclosed herein. In embodiments of the disclosure, the upper limit on the LCBF of the polyethylene composition may be 0.5000, or 0.4000, or 0.3000 (dimensionless). In embodiments of the disclosure, the lower limit on the LCBF of the polyethylene composition may be 0.0010, or 0.0020, or 0.0050, or 0.0100, or 0.0500, or 0.1000 (dimensionless).

In embodiments of the disclosure, the LCBF of the polyethylene composition is at least 0.0010, or at least 0.0020, or at least 0.0050, or at least 0.0070, or at least 0.0100, or at least 0.0200, or at least 0.0250.

In embodiments of the disclosure, the LCBF of the polyethylene composition may be >0.0010, or >0.0050, or >0.0100, or >0.0200 (dimensionless).

In embodiments of the disclosure, the LCBF of the polyethylene composition may be from 0.0010 to 0.5000, or from 0.0010 to 0.1000, or from 0.0050 to 0.5000, or from 0.0050 to 0.1000, or from 0.0070 to 0.5000, or from 0.0050 to 0.2500, or from 0.0070 to 0.2500, or from 0.0100 to 0.5000, or from 0.0100 to 0.2500, or from 0.0050 to 0.1000, or from 0.0070 to 0.1000, or from 0.0100 to 0.1000.

In embodiments of the disclosure, the polyethylene composition has a melt strength of at least 2.0 cN, or at least 2.5 cN, or at least 3.0 cN.

In embodiments of the disclosure, the polyethylene composition or a plaque made from the polyethylene composition has a flexural secant modulus at 1%, of at least 900 MPa, or at least 1000 MPa, or at least 1100 MPa, or at least 1200 MPa. In further embodiments of the disclosure the polyethylene composition has a flexural secant modulus at 1% of from 900 to 1600 MPa, including any narrower ranges within this range and any values encompassed by these ranges. For example, in embodiments of the disclosure, the polyethylene composition has a flexural secant modulus at 1% of from 1000 to 1500 MPa, or from 1000 to 1400 MPa, or from 1100 to 1500 MPa, or from 1100 to 1400 MPa, or from 1200 to 1500 MPa, or from 1200 to 1400 MPa.

In embodiments of the disclosure, the polyethylene composition or a plaque made from the polyethylene composition has a tensile secant modulus at 1%, of at least 900 MPa, or at least 1000 MPa, or at least 1100 MPa, or at least 1200 MPa. In further embodiments of the disclosure the polyethylene composition has a tensile secant modulus at 1% of from 900 to 1600 MPa, including any narrower ranges within this range and any values encompassed by these ranges. For example, in embodiments of the disclosure, the polyethylene composition has a tensile secant modulus at 1% of from 900 to 1500 MPa, or from 1000 to 1500 MPa, or from 900 to 1400 MPa, or from 1000 to 1400 MPa, or from 1100 to 1500 MPa, or from 1200 to 1500 MPa, or from 1100 to 1400 MPa, or from 1200 to 1400 MPa.

In embodiments of the disclosure, the polyethylene composition or a plaque made from the polyethylene composition has an IZOD Impact strength of ≥1.0 foot.pound/inch, or >1.0 foot.pound/inch, or ≥1.5 foot.pound/inch, or >1.5 foot.pound/inch, or ≥2.0 foot.pound/inch, or >2.5 foot.pound/inch, or ≥3.0 foot.pound/inch, or >3.0 foot.pound/inch. In further embodiments of the disclosure the polyethylene composition has an IZOD impact strength of from 1.0 to 8 foot.pound/inch, including any narrower ranges within this range and any values encompassed by these ranges. For example, in embodiments of the disclosure, the polyethylene composition has an IZOD impact strength of from 1.5 to 8 foot.pound/inch, or from 1.5 to 6 foot.pound/inch, or from 1.5 to 5.5 foot.pound/inch.

In embodiments of the disclosure, the polyethylene composition or a plaque made from the polyethylene composition has an environmental stress crack resistance, ESCR at condition A in 100% IGEPAL CO-630 of greater than 400 hours, or greater than 600 hours, or greater than 800 hours, or greater than 1000 hours, or greater than 1100 hours.

In embodiments of the disclosure, the polyethylene composition or a plaque made from the polyethylene composition has an environmental stress crack resistance, ESCR at condition B in 100% IGEPAL CO-630 of greater than 400 hours, or greater than 600 hours, or greater than 800 hours, or greater than 1000 hours, or greater than 1100 hours.

In embodiments of the disclosure, the polyethylene composition or a plaque made from the polyethylene composition has an environmental stress crack resistance, ESCR determined at both condition A and at condition B, in 100% IGEPAL CO-630, of greater than 400 hours, or greater than 600 hours, or greater than 800 hours, or greater than 1000 hours, or greater than 1100 hours.

In embodiments of the disclosure, the polyethylene composition or a plaque made from the polyethylene composition has an environmental stress crack resistance, ESCR determined at either condition A or at condition B, in 100% IGEPAL CO-630, of greater than 400 hours, or greater than 600 hours, or greater than 800 hours, or greater than 1000 hours, or greater than 1100 hours.

In embodiments of the disclosure, the polyethylene composition has a shear thinning index, SHI_{(1,100)} of >5.0, or >7.5, or ≥10.0, or ≥15.0, or ≥20.0. In embodiments of the disclosure, the polyethylene composition has a shear thinning index, SHI(1,100, of from 7.5 to 40, including any narrower ranges within this range and any values encompassed by these ranges. For example, in embodiments of the disclosure, the polyethylene composition has a shear thinning index, SHI_{(1,100)} of from 10.0 to 40.0, or from 7.5 to 35.0, or from 10.0 to 35.0, or from 15.0 to 40.0, or from 15.0 to 35.0.

In embodiments of the disclosure, the polyethylene composition has a relative elasticity, G′/G″ at 0.05 rad/s of ≤0.75, or ≤0.70, or ≤0.60, or ≤0.50. In embodiments of the disclosure, the polyethylene composition has a relative elasticity, G′/G″ at 0.05 rad/s of from 0.25 to 0.75, including any narrower ranges within this range and any values encompassed by these ranges. For example, in embodiments of the disclosure, the polyethylene composition has a relative elasticity, G′/G″ at 0.05 rad/s of from 0.25 to 0.60, or from 0.25 to 0.55, or from 0.25 to 0.50.

Additives can be added to the polyethylene composition during an extrusion or compounding step, but other suitable known methods will be apparent to a person skilled in the art. The additives can be added as is or as part of a separate polymer component (i.e., not the first or second ethylene polymers described above) added during an extrusion or compounding step. Suitable additives are known in the art and include but are not-limited to antioxidants, phosphites and phosphonites, nitrones, antacids, UV light stabilizers, UV absorbers, metal deactivators, dyes, fillers and reinforcing agents, nano-scale organic or inorganic materials, antistatic agents, lubricating agents such as calcium stearates, slip additives such as crucimide, and nucleating agents (including nucleators, pigments or any other chemicals which may provide a nucleating effect to the polyethylene composition). The additives that can be optionally added are typically added in amount of up to 20 weight percent (wt %).

One or more nucleating agent(s) may be introduced into the polyethylene composition by kneading a mixture of the polymer, usually in powder or pellet form, with the nucleating agent, which may be utilized alone or in the form of a concentrate containing further additives such as stabilizers, pigments, antistatics, UV stabilizers and fillers. It should be a material which is wetted or absorbed by the polymer, which is insoluble in the polymer and of melting point higher than that of the polymer, and it should be homogeneously dispersible in the polymer melt in as fine a form as possible (1 to 10 μm). Compounds known to have a nucleating capacity for polyolefins include salts of aliphatic monobasic or dibasic acids or arylalkyl acids, such as sodium succinate or aluminum phenylacetate; and alkali metal or aluminum salts of aromatic or alicyclic carboxylic acids such as sodium B-naphthoate. Another compound known to have nucleating capacity is sodium benzoate. The effectiveness of nucleation may be monitored microscopically by observation of the degree of reduction in size of the spherulites into which the crystallites are aggregated.

Examples of nucleating agents which are commercially available and which may be added to the polyethylene composition are dibenzylidene sorbital esters (such as the products sold under the trademark MILLAD® 3988 by Milliken Chemical and IRGACLEAR® by Ciba Specialty Chemicals). Further examples of nucleating agents which may added to the polyethylene composition include the cyclic organic structures disclosed in U.S. Pat. No. 5,981,636 (and salts thereof, such as disodium bicyclo[2.2.1] heptene dicarboxylate); the saturated versions of the structures disclosed in U.S. Pat. No. 5,981,636 (as disclosed in U.S. Pat. No. 6,465,551; Zhao et al., to Milliken); the salts of certain cyclic dicarboxylic acids having a hexahydrophthalic acid structure (or “HHPA” structure) as disclosed in U.S. Pat. No. 6,599,971 (Dotson et al., to Milliken); and phosphate esters, such as those disclosed in U.S. Pat. No. 5,342,868 and those sold under the trade names NA-11 and NA-21 by Asahi Denka Kogyo, cyclic dicarboxylates and the salts thereof, such as the divalent metal or metalloid salts, (particularly, calcium salts) of the HHPA structures disclosed in U.S. Pat. No. 6,599,971. For clarity, the HHPA structure generally comprises a ring structure with six carbon atoms in the ring and two carboxylic acid groups which are substituents on adjacent atoms of the ring structure. The other four carbon atoms in the ring may be substituted, as disclosed in U.S. Pat. No. 6,599,971. An example is 1,2-cyclohexanedicarboxylicacid, calcium salt (CAS registry number 491589-22-1). Still further examples of nucleating agents which may added to the polyethylene composition include those disclosed in WO2015042561, WO2015042563, WO2015042562 and WO 2011050042.

Many of the above described nucleating agents may be difficult to mix with the polyethylene composition that is being nucleated and it is known to use dispersion aids, such as for example, zinc stearate, to mitigate this problem.

In an embodiment of the disclosure, the nucleating agents are well dispersed in the polyethylene composition.

In an embodiment of the disclosure, the amount of nucleating agent used is comparatively small (from 5 to 3000 parts by million per weight (based on the weight of the polyethylene composition)) so it will be appreciated by those skilled in the art that some care must be taken to ensure that the nucleating agent is well dispersed. In an embodiment of the disclosure, the nucleating agent is added in finely divided form (less than 50 microns, especially less than 10 microns) to the polyethylene composition to facilitate mixing. This type of “physical blend” (i.e., a mixture of the nucleating agent and the resin in solid form) is generally preferable to the use of a “masterbatch” of the nucleator (where the term “masterbatch” refers to the practice of first melt mixing the additive—the nucleator, in this case—with a small amount of the polyethylene composition resin—then melt mixing the “masterbatch” with the remaining bulk of the polyethylene composition resin).

In an embodiment of the disclosure, an additive such as nucleating agent may be added to the polyethylene composition by way of a “masterbatch”, where the term “masterbatch” refers to the practice of first melt mixing the additive (e.g., a nucleator) with a small amount of the polyethylene composition, followed by melt mixing the “masterbatch” with the remaining bulk of the polyethylene composition.

In an embodiment of the disclosure, the polyethylene composition further comprises a nucleating agent or a mixture of nucleating agents.

In an embodiment of the disclosure, the polyethylene composition is used in the formation of molded articles. For example, articles formed by rotomolding, continuous compression molding and injection molding are contemplated. Such articles include, for example, tanks from rotomolding, and caps, screw caps, and closures for bottles from compression or injection molding. However, a person skilled in the art will readily appreciate that the compositions described above may also be used for other applications such as, but not limited to, film, injection blow molding, blow molding, sheet extrusion, foam injection molding, and foam extrusion sheet applications.

In an embodiment, the polyethylene composition disclosed herein may be converted into molded articles.

In an embodiment, the polyethylene composition disclosed herein may be converted into extrusion molded articles.

In an embodiment, the polyethylene composition disclosed herein may be converted into extrusion coated articles.

In an embodiment, the polyethylene composition disclosed herein may be converted into rotomolded articles.

In an embodiment, the polyethylene composition disclosed herein may be converted into a foamed article.

In another embodiment, and as an alternative to rotomolding, the polyethylene composition of the present disclosure may be used to manufacture articles by compression molding or injection molding processes.

In an embodiment, the polyethylene composition disclosed herein may be converted into a cap or closure.

### Foamed Articles

Polyethylene foam is typically characterized based on its density. Soft, or low density polyethylene foam is typically prepared from a polyethylene resin which is also characterized by having a low density. Rigid foam on the other hand, can be used in structural applications. Rigid polyethylene foam, characterized by having a higher density, generally provides higher tensile and compressive strength than lower density polyethylene foam. Foamed polyolefins may afford advantages in the design of molded parts as they provide opportunities to reduce the overall part weight as well as improve insulation properties, both thermal and acoustic. High pressure low density polyethylene (HPLDPE) is often used in the preparation of soft foam articles. Linear low density polyethylene polymers (LLDPE) are also used in various foam applications. The choice of resin, blowing agent, molding equipment and part design all contribute to the performance of the molded part.

Known processes used to prepare polyolefin foams include sheet extrusion, blown film and cast film extrusion, injection molding, rotational molding, and compression molding, and all of these processes are contemplated for use in embodiments of the present disclosure to prepare a foamed article using the polyethylene composition disclosed herein.

As is known to persons skilled in the art, a blowing agent is used to produce a foamed polyethylene structure and the blowing agent can either be physical or chemical in nature. Physical blowing agents are gases which are typically first dissolved in the polymer melt and subsequently separated when forming a cellular structure with changes in the pressure (decompression) during the foaming process. Examples of physical blowing agents include nitrogen, argon, carbon dioxide, fluorocarbons, helium, and hydrocarbons such as butanes and pentanes. Chemical blowing agents are chemicals which decompose during the foaming operation to produce gas which in turns forms the cellular structure. Examples of such chemical blowing agents include synthetic azo-, carbonate-, and hydrazide-based molecules. Typically, decomposition of the blowing agent liberates gas such as nitrogen, carbon dioxide, and/or wager (steam). During the foaming process, the chemical blowing agent may be activated by heating the mixture to a temperature above its decomposition temperature. The amount of chemical blowing agent in the foamable polyethylene composition is usually chosen based on the foam density required.

It is well known that higher melt strength generally improves the polymer foaming process and the foam quality. High pressure low density polyethylene (HPLDPE) typically contains long chain branching which may improve melt strength and facilitate the foaming process. HPLDPE resins may, however, be limited in their end use application by their relatively low density. In contrast and without wishing to be bound by theory, the polyethylene composition of the present disclosure present rheological characteristics and melt strengths that are desirable for foaming applications.

### Rotomolded Articles

Typically, for use in a rotational molding process, a polyethylene composition is manufactured in powder or pellet form. The rotational molding process may additionally comprise process steps for manufacturing the polyethylene composition. For rotational molding, powders are preferably used and may have a particle size smaller than or equal to 35 US mesh. Polymer composition grinding may be done cryogenically, if preferable. Thereafter, a polymer powder is placed inside a hollow mold and then heated within the mold as the mold is rotated. A mold is usually rotated biaxially, i.e., rotated about two perpendicular axes simultaneously. A mold is typically heated externally (generally with a forced air circulating oven). Generally, rotomolding process steps include: tumbling, heating and melting of a polymer powder, followed by coalescence, fusion or sintering and cooling to remove the molded article.

The polyethylene composition of the present disclosure may in certain embodiments of the disclosure, be processed in commercial rotational molding machines. The time and temperatures used will depend upon factors including the thickness of the part being rotomolded, and one skilled in the art can readily determine suitable processing conditions. By way of providing some non-limiting examples, the oven temperature range during the heating step may be from 400ºF to 800ºF, or from about 500ºF to about 700ºF, or from about 575° F. to about 650° F.

After the heating step the mold is cooled. The part must be cooled enough to be easily removed from the mold and to retain its shape. The mold may be removed from the oven while continuing to rotate. Cool air is first blown on the mold. The air may be at ambient temperature. After the air has started to cool the mold for a controlled time period, a water spray may be used. The water cools the mold more rapidly. The water used may be at cold tap water temperature, for example it may be from about 4° C. (40ºF) to about 16° C. (60ºF). After the water cooling step, another air cooling step may be used. This may be a short step during which the equipment dries with heat removal during the evaporation of the water.

The heating and cooling cycle times will depend on the equipment used and the article being molded. Specific factors include the part thickness in the mold material. By way of providing a non-limiting example, conditions for an ⅛ inch thick part in a steel mold may be, to heat the mold in the oven with air at about 316° C. (600ºF) for about 15 minutes; the part may then be cooled in ambient temperature forced air for about 8 minutes and then a tap water spray at about 10° C. (50ºF) for about 5 minutes; optionally, the part may be cooled in ambient temperature forced air for an additional 2 minutes.

During the heating and cooling steps the mold containing the molded article is preferably continually rotated. Typically this is done along two perpendicular axes. The rate of rotation of the mold about each axis is limited by machine capability and the shape of the article being molded. A typical, non-limiting range of operations which may be used with the present disclosure is to have the ratio of rotation of the major axis to the minor axis of about 1:8 to 10:1 or from about 1:2 to 8:1.

Non-limiting examples of articles which can be made using a rotomolding process include custom tanks, water tanks, carts, transportation cases and containers, coolers, as well as sports and recreation equipment (e.g. boats, kayaks), toys, and playground equipment.

The desired physical properties of rotomolded articles depend on the application of interest. Non-limiting examples of desired properties include: flexural modulus (1% and 2% secant modulus); environmental stress crack resistance (ESCR); shore hardness; heat deflection temperature (HDT); VICAT softening point; IZOD impact strength; ARM impact resistance; and color (whiteness and/or yellowness index).

In an embodiment of the disclosure, a polyethylene composition having a melt index (12) of from 0.8 to 4.0 g/10 min is used to prepare rotomolded articles having an interior volume of from about 500 to 22,000 liters.

In an embodiment of the disclosure a process for making a rotomolded article comprises the following steps: (i) charging the polyethylene composition into a mold; (ii) heating the mold in an oven to a temperature of more than 280° C.; (iii) rotating the mold around at least 2 axes; (iv) cooling the mold while the mold is rotating; and (v) opening the mold to release the rotomolded article.

### Additives and Adjuvants—Rotomolded Articles

The polyethylene compositions and the manufactured rotomolded articles described may optionally include, depending on its intended use, additives and adjuvants. Additives can be added to the polyethylene composition during an extrusion or compounding step, but other suitable known methods will be apparent to a person skilled in the art. The additives can be added as is or as part of a separate polymer component added during an extrusion or compounding step. Non-limiting examples of additives and adjuvants include, anti-blocking agents, antioxidants, heat stabilizers, slip agents, processing aids, anti-static additives, colorants, dyes, filler materials, light stabilizers, heat stabilizers, light absorbers, lubricants, pigments, plasticizers, nucleating agents and combinations thereof. Non-limiting examples of suitable primary antioxidants include IRGANOX® 1010 [CAS Reg. No. 6683-19-8] and IRGANOX 1076 [CAS Reg. No. 2082-79-3]; both available from BASF Corporation, Florham Park, NJ, U.S.A. Non-limiting examples of suitable secondary antioxidants include IRGAFOS® 168 [CAS Reg. No. 31570-04-4], available from BASF Corporation, Florham Park, NJ, U.S.A.; WESTON® 705 [CAS Reg. No. 939402-02-5], available from Addivant, Danbury, CT, U.S.A.; and DOVERPHOS® IGP-11 [CAS Reg. No. 1227937-46-3] available form Dover Chemical Corporation, Dover OH, U.S.A. The additives that can be optionally added are typically added in amount of up to 20 weight percent (wt %).

One or more nucleating agent(s) may be introduced into the polyethylene composition by kneading a mixture of the polymer, usually in powder or pellet form, with the nucleating agent, which may be utilized alone or in the form of a concentrate containing further additives such as stabilizers, pigments, antistatics, UV stabilizers and fillers. It should be a material which is wetted or absorbed by the polymer, which is insoluble in the polymer and of melting point higher than that of the polymer, and it should be homogeneously dispersible in the polymer melt in as fine a form as possible (1 to 10 μm). Compounds known to have a nucleating capacity for polyolefins include salts of aliphatic monobasic or dibasic acids or arylalkyl acids, such as sodium succinate or aluminum phenylacetate; and alkali metal or aluminum salts of aromatic or alicyclic carboxylic acids such as sodium B-naphthoate. Another compound known to have nucleating capacity is sodium benzoate. The effectiveness of nucleation may be monitored microscopically by observation of the degree of reduction in size of the spherulites into which the crystallites are aggregated.

In embodiments of the disclosure, the polyethylene composition and the manufactured rotomolded articles described may include additives selected from the group comprising antioxidants, phosphites and phosphonites, nitrones, antacids, UV light stabilizers, UV absorbers, metal deactivators, dyes, fillers and reinforcing agents, nano-scale organic or inorganic materials, antistatic agents, release agents such as zinc stearates, and nucleating agents (including nucleators, pigments or any other chemicals which may provide a nucleating effect to the polyethylene composition).

In embodiments of the disclosure, the additives that can be added are added in an amount of up to 20 weight percent (wt %).

Additives can be added to the polyethylene composition during an extrusion or compounding step, but other suitable known methods will be apparent to a person skilled in the art. The additives can be added as is or as part of a separate polymer component added during an extrusion or compounding step.

A more detailed list of additives which may be added to the polyethylene composition of the present disclosure and which are used in rotomolded articles follows:

Phosphites (e.g. Aryl Monophosphite)

As used herein, the term aryl monophosphite refers to a phosphite stabilizer which contains: (1) only one phosphorus atom per molecule; and (2) at least one aryloxide (which may also be referred to as phenoxide) radical which is bonded to the phosphorus.

In an embodiment of the disclosure, aryl monophosphites contain three aryloxide radicals—for example, tris phenyl phosphite is the simplest member of this preferred group of aryl monophosphites.

In another embodiment of the disclosure, aryl monophosphites contain C₁ to C₁₀ alkyl substituents on at least one of the aryloxide groups. These substituents may be linear (as in the case of nonyl substituents) or branched (such as isopropyl or tertiary butyl substituents).

Non-limiting examples of aryl monophosphites which may be used in embodiments of the disclosure, include those selected from triphenyl phosphite; diphenyl alkyl phosphites; phenyl dialkyl phosphites; tris(nonylphenyl) phosphite [WESTON 399, available from GE Specialty Chemicals]; tris(2,4-di-tert-butylphenyl) phosphite [IRGAFOS 168, available from Ciba Specialty Chemicals Corp.]; and bis(2,4-di-tert-butyl-6-methylphenyl) ethyl phosphite [IRGAFOS 38, available from Ciba Specialty Chemicals Corp.]; and 2,2′,2″-nitrilo[triethyltris(3,3′5,5′-tetra-tert-butyl-1,1′-biphenyl-2,2′-diyl) phosphite [IRGAFOS 12, available from Ciba Specialty Chemicals Corp.].

In embodiments of the disclosure, the amount of aryl monophosphite added to the polyethylene composition is added in from 200 to 2,000 ppm (based on the weight of the polymer), or from 300 to 1,500 ppm, or from 400 to 1,000 ppm.

Phosphites, Phosphonites (e.g. Diphosphite, Diphosphonite)

As used herein, the term diphosphite refers to a phosphite stabilizer which contains at least two phosphorus atoms per phosphite molecule (and, similarly, the term diphosphonite refers to a phosphonite stabilizer which contains at least two phosphorus atoms per phosphonite molecule).

Non-limiting examples of diphosphites and diphosphonites which may be used in embodiments of the disclosure include those selected from distearyl pentaerythritol diphosphite, diisodecyl pentaerythritol diphosphite, bis(2,4 di-tert-butylphenyl) pentaerythritol diphosphite [ULTRANOXR 626, available from GE Specialty Chemicals]; bis(2,6-di-tert-butyl-4-methylpenyl) pentaerythritol diphosphite; bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tetrakis(2,4-di-tert-butylphenyl)4,4′-bipheylene-diphosphonite [IRGAFOS P-EPQ, available from Ciba] and bis(2,4-dicumylphenyl)pentaerythritol diphosphite [DOVERPHOS S9228-T or DOVERPHOS S9228-CT] and PEPQ® (CAS No 119345-01-06), which is an example of a commercially available diphosphonite.

In embodiments of the disclosure, the diphosphite and/or diphosphonite added to the polyethylene composition is added in from 200 ppm to 2,000 ppm (based on the weight of the polymer), or from 300 to 1,500 ppm, or from 400 to 1,000 ppm.

In an embodiment of the disclosure, the use of diphosphites is preferred over the use of diphosphonites.

In an embodiment of the disclosure, the most preferred diphosphites are those available under the trademarks DOVERPHOS S9228-CT and ULTRANOX 626.

### Hindered Phenolic Antioxidant

The hindered phenolic antioxidant may be any of the molecules that are conventionally used as primary antioxidants for the stabilization of polyolefins. Suitable examples include 2,6-di-tert-butyl-4-methylphenol; 2-tert-butyl-4,6-dimethylphenol; 2,6-di-tert-butyl-4-ethylphenol; 2,6-di-tert-butyl-4-n-butylphenol; 2,6-di-tert-butyl-4isobutylphenol; 2,6-dicyclopentyl-4-methylphenol; 2-(.alpha.-methylcyclohexyl)-4,6 dimethylphenol; 2,6-di-octadecyl-4-methylphenol; 2,4,6,-tricyclohexyphenol; and 2,6-di-tert-butyl-4-methoxymethylphenol.

Two (non limiting) examples of suitable hindered phenolic antioxidants which can be used in embodiments of the disclosure, are sold under the trademarks IRGANOX 1010 (CAS Registry number 6683-19-8) and IRGANOX 1076 (CAS Registry number 2082-79-3) by BASF Corporation.

In an embodiment of the disclosure, the amount of hindered phenolic antioxidant added to the polyethylene composition is added in from 100 to 2,000 ppm, or from 400 to 1,000 ppm (based on the weight of the polymer).

### Long Term Stabilizers

Plastic parts which are intended for long term use, can in embodiments of the present disclosure, contain at least one Hindered Amine Light Stabilizer (HALS). HALS are well known to those skilled in the art.

When employed, the HALS may in an embodiment of the disclosure be a commercially available material and may be used in a conventional manner and in a conventional amount.

Commercially available HALS which may be used in embodiments of the disclosure include those sold under the trademarks CHIMASSORB® 119; CHIMASSORB 944; CHIMASSORB 2020; TINUVIN® 622 and TINUVIN 770 from Ciba Specialty Chemicals Corporation, and CYASORB® UV 3346, CYASORB UV 3529, CYASORB UV 4801, and CYASORB UV 4802 from Cytec Industries. In some embodiments of the disclosure, TINUVIN 622 is preferred. In other embodiments of the disclosure, the use of mixtures of more than one HALS are also contemplated.

In embodiments of the disclosure, suitable HALS include those selected from bis(2,2,6,6-tetramethylpiperidyl)-sebacate; bis-5(1,2,2,6,6-pentamethylpiperidyl)-sebacate; n-butyl-3,5-di-tert-butyl-4-hydroxybenzyl malonic acid bis(1,2,2,6,6,-pentamethylpiperidyl)ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylendiamine and 4-tert-octylamino-2,6-dichloro-1,3,5-s-triazine; tris-(2,2,6,6-tetramethylpiperidyl)-nitrilotriacetate, tetrakis-(2,2,6,6-tetramethyl-4-piperidyl)-1,2,3,4butane-tetra-arbonic acid; and 1,1′(1,2-ethanediyl)-bis-(3,3,5,5-tetramethylpiperazinone).

### Hydroxylamines

It is known to use hydroxylamines and derivatives thereof (including amine oxides) as additives for polyethylene compositions used to prepare rotomolded parts, as disclosed in for example U.S. Pat. No. 6,444,733 and in embodiments of the present disclosure, the hydroxylamines and derivatives disclosed in this patent may also be suitable for use.

In an embodiment of the disclosure, a useful hydroxylamine for inclusion in the polyethylene composition can be selected from N,N-dialkylhydroxylamines, a commercially available example of which is the N,N-di(alkyl) hydroxylamine sold as IRGASTAB 042 (by BASF) and which is reported to be prepared by the direct oxidation of N,N-di(hydrogenated) tallow amine.

In an embodiment of the disclosure, the polyethylene composition contains an additive package comprising: a hindered monophosphite; a diphosphite; a hindered amine light stabilizer, and at least one additional additive selected from the group consisting of a hindered phenol and a hydroxylamine.

### Cap or Closure As Molded Article

In an embodiment of the disclosure, the polyethylene composition is used in the formation of any closure, of any suitable design and dimensions for use in sealing any suitable bottle, container or the like.

In an embodiment of the disclosure, the polyethylene compositions are used in the formation of a closure for bottles, containers, pouches and the like. For example, closures for bottles formed by continuous compression molding, or injection molding are contemplated. Such closures include, for example, hinged caps, hinged screw caps, hinged snap-top caps, and hinged closures for bottles, containers, pouches and the like.

In an embodiment of the disclosure, a closure (or cap) is a screw cap for a bottle, container, pouches and the like.

In an embodiment of the disclosure, a closure (or cap) is a snap closure for a bottle, container, pouches and the like.

In an embodiment of the disclosure, a closure (or cap) comprises a hinge made of the same material as the rest of the closure (or cap).

In an embodiment of the disclosure, a closure (or cap) is hinged closure.

In an embodiment of the disclosure, a closure (or cap) is a hinged closure for bottles, containers, pouches and the like.

In an embodiment of the disclosure, a closure (or cap) is a flip-top hinge closure, such as a flip-top hinge closure for use on a plastic ketchup bottle or similar containers containing foodstuffs.

When a closure is a hinged closure, it comprises a hinged component and generally consists of at least two bodies which are connected by a thinner section that acts as a hinge allowing the at least two bodies to bend from an initially molded position. The thinner section may be continuous or web-like, wide or narrow.

A useful closure (for bottles, containers and the like) is a hinged closure and may consist of two bodies joined to each other by at least one thinner bendable portion (e.g. the two bodies can be joined by a single bridging portion, or more than one bridging portion, or by a webbed portion, etc.). A first body may contain a dispensing hole and which may snap onto or screw onto a container to cover a container opening (e.g. a bottle opening) while a second body may serve as a snap on lid which may mate with the first body.

The caps and closures, of which hinged caps and closures and screw caps are a subset, can be made according to any known method, including for example injection molding and compression molding techniques that are well known to persons skilled in the art. Hence, in an embodiment of the disclosure a closure (or cap) comprising the polyethylene composition (described herein) is prepared with a process comprising at least one compression molding step and/or at least one injection molding step.

In one embodiment, the closures (including single piece or multi-piece variants and hinged variants) are well suited for sealing bottles, containers and the like, for examples bottles that may contain drinkable water, and other foodstuffs, including but not limited to liquids that are under an appropriate pressure (i.e. carbonated beverages or appropriately pressurized drinkable liquids).

The closures and caps may also be used for sealing bottles containing drinkable water or non-carbonated beverages (e.g. juice). Other applications, include caps and closures for bottles, containers and pouches containing foodstuffs, such as for example ketchup bottles and the like.

The closures and caps may be one-piece closures or two piece closures comprising a closure and a liner.

The closures and caps may also be of multilayer design, wherein the closure of cap comprises at least two layers at least one of which is made of the polyethylene compositions described herein.

In an embodiment of the disclosure the closure is made by continuous compression molding.

In an embodiment of the disclosure the closure is made by injection molding.

Further non-limiting details of the disclosure are provided in the following examples. The examples are presented for the purposes of illustrating selected embodiments of this disclosure, it being understood that the examples presented do not limit the claims presented.

### Examples

Prior to testing, each specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Polyethylene composition densities were determined using ASTM D792-13 (Nov. 1, 2013).

### Melt Index

The polyethylene composition melt index was determined using ASTM D1238 (Aug. 1, 2013). Melt indexes, I₂, I₆, I₁₀ and I₂₁ were measured at 190° C., using weights of 2.16 kg, 6.48 kg, 10 kg and a 21.6 kg respectively. Herein, the term “stress exponent” or its acronym “S.Ex.”, is defined by the following relationship:

S.Ex.=log (I₆/I₂)/log(6480/2160)

wherein I₆ and I₂ are the melt flow rates measured at 190° C. using 6.48 kg and 2.16 kg loads, respectively. In this disclosure, melt index was expressed using the units of g/10 minutes or g/10 min or dg/minutes or dg/min; these units are equivalent.

### Gel Permeation Chromatography (GPC)

Polyethylene composition molecular weights, Mₙ, M_{w} and M_{z}, as well the as the polydispersity (M_{w}/Mₙ), were determined using ASTM D6474-12 (Dec. 15, 2012). Polymer sample solutions (1 to 2 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a PL 220 high-temperature chromatography unit equipped with four Shodex columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect GPC columns from oxidative degradation. The sample injection volume was 200 μL. The GPC raw data were processed with the CIRRUS® GPC software. The GPC columns were calibrated with narrow distribution polystyrene standards. The polystyrene molecular weights were converted to polyethylene molecular weights using the Mark-Houwink equation, as described in ASTM D6474-12 (Dec. 15, 2012).

### Triple Detection Size Exclusion Chromatography (3D-SEC)

Polyethylene composition samples (polymer) solutions (1 to 3 mg/mL) were prepared by heating the polymer in 1,2,4-trichlorobenzene (TCB) and rotating on a wheel for 4 hours at 150° C. in an oven. An antioxidant (2,6-di-tert-butyl-4-methylphenol (BHT)) was added to the mixture in order to stabilize the polymer against oxidative degradation. The BHT concentration was 250 ppm. Sample solutions were chromatographed at 140° C. on a PL 220 high-temperature chromatography unit equipped with a differential refractive index (DRI) detector, a dual-angle light scattering detector (15 and 90 degree) and a differential viscometer. The SEC columns used were either four Shodex columns (HT803, HT804, HT805 and HT806), or four PL Mixed ALS or BLS columns. TCB was the mobile phase with a flow rate of 1.0 mL/minute, BHT was added to the mobile phase at a concentration of 250 ppm to protect SEC columns from oxidative degradation. The sample injection volume was 200 μL. The SEC raw data were processed with the CIRRUS GPC software, to produce absolute molar masses and intrinsic viscosity ([η]). The term “absolute” molar mass was used to distinguish 3D-SEC determined absolute molar masses from the molar masses determined by conventional SEC. The viscosity average molar mass (Mᵥ) determined by 3D-SEC was used in the calculations to determine the Long Chain Branching Factor (LCBF).

### GPC-FTIR

Polyethylene composition (polymer) solutions (2 to 4 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a Waters GPC 150C chromatography unit equipped with four Shodex columns (HT803, HT804, HT805 and HT806) using TCB as the mobile phase with a flow rate of 1.0 mL/minute, with a FTIR spectrometer and a heated FTIR flow through cell coupled with the chromatography unit through a heated transfer line as the detection system. BHT was added to the mobile phase at a concentration of 250 ppm to protect SEC columns from oxidative degradation. The sample injection volume was 300 μL. The raw FTIR spectra were processed with OPUS FTIR software and the polymer concentration and methyl content were calculated in real time with the Chemometric Software (PLS technique) associated with the OPUS. Then the polymer concentration and methyl content were acquired and baseline-corrected with the CIRRUS GPC software. The SEC columns were calibrated with narrow distribution polystyrene standards. The polystyrene molecular weights were converted to polyethylene molecular weights using the Mark-Houwink equation, as described in the ASTM standard test method D6474. The comonomer content was calculated based on the polymer concentration and methyl content predicted by the PLS technique as described in Paul J. DesLauriers, Polymer 43, pages 159-170 (2002); herein incorporated by reference.

The GPC-FTIR method measures total methyl content, which includes the methyl groups located at the ends of each macromolecular chain, i.e. methyl end groups. Thus, the raw GPC-FTIR data must be corrected by subtracting the contribution from methyl end groups. To be more clear, the raw GPC-FTIR data overestimates the amount of short chain branching (SCB) and this overestimation increases as molecular weight (M) decreases. In this disclosure, raw GPC-FTIR data was corrected using the 2-methyl correction. At a given molecular weight (M), the number of methyl end groups (N_{E}) was calculated using the following equation; N_{E}=28000/Mₙ and N_{E} (M dependent) was subtracted from the raw GPC-FTIR data to produce the SCB/1000C (2-Methyl Corrected) GPC-FTIR data.

### Unsaturation Content

The quantity of unsaturated groups, i.e., double bonds, in a polyethylene composition was determined according to ASTM D3124-98 (vinylidene unsaturation, published March 2011) and ASTM D6248-98 (vinyl and trans unsaturation, published July 2012). A polymer sample was: a) first subjected to a carbon disulfide extraction to remove additives that may interfere with the analysis; b) the sample (pellet, film or granular form) was pressed into a plaque of uniform thickness (0.5 mm); and c) the plaque was analyzed by FTIR.

### Comonomer Content: Fourier Transform Infrared (FTIR) Spectroscopy

The quantity of comonomer in a polyethylene composition was determined by FTIR and reported as the Short Chain Branching (SCB) content having dimensions of CH_{3 #/1000}C (number of methyl branches per 1000 carbon atoms). This test was completed according to ASTM D6645-01 (2001), employing a compression molded polymer plaque and a Thermo-Nicolet 750 Magna-IR Spectrophotometer. The polymer plaque was prepared using a compression molding device (Wabash-Genesis Series press) according to ASTM D4703-16 (April 2016).

### Composition Distribution Branching Index (CDBI) by CTREF

The “Composition Distribution Branching Index” or “CDBI” of the disclosed Examples and Comparative Examples were determined using a crystal-TREF unit (a “CTREF” unit) commercially available form Polymer Char (Valencia, Spain). The acronym “TREF” refers to Temperature Rising Elution Fractionation. A sample of polyethylene composition (80 to 100 mg) was placed in the reactor of the Polymer ChAR crystal-TREF unit, the reactor was filled with 35 ml of 1,2,4-trichlorobenzene (TCB), heated to 150° C. and held at this temperature for 2 hours to dissolve the sample. An aliquot of the TCB solution (1.5 mL) was then loaded into the Polymer Char TREF column filled with stainless steel beads and the column was equilibrated for 45 minutes at 110° C. The polyethylene composition was then crystallized from the TCB solution, in the TREF column, by slowly cooling the column from 110° C. to 30° C. using a cooling rate of 0.09° C. per minute. The TREF column was then equilibrated at 30ºC for 30 minutes. The crystallized polyethylene composition was then eluted from the TREF column by passing pure TCB solvent through the column at a flow rate of 0.75 mL/minute as the temperature of the column was slowly increased from 30° C. to 120° C. using a heating rate of 0.25° C. per minute. Using Polymer Char software, a TREF distribution curve was generated as the polyethylene composition was eluted from the TREF column, i.e., a TREF distribution curve is a plot of the quantity (or intensity) of polymeric material eluting from the column as a function of TREF elution temperature. A CDBI₅₀ was calculated from the TREF distribution curve for each polyethylene composition analyzed. The “CDBI₅₀” is defined as the percent of polymer whose composition is within 50% of the median comonomer composition (25% on each side of the median comonomer composition); this definition is consistent with that described in WO 93/03093 assigned to Exxon Chemical Patents Inc; it is calculated from the TREF composition distribution curve and the normalized cumulative integral of the TREF composition distribution curve. Those skilled in the art will understand that a calibration curve is required to convert a TREF elution temperature to comonomer content, i.e., the amount of comonomer in the polyethylene composition fraction that elutes at a specific temperature. The generation of such calibration curves are described in the prior art, e.g., Wild, et al., J. Polym. Sci., Part B, Polym. Phys., Vol. 20 (3), pages 441-455.

### Hexane Extractables

Hexane extractables was determined according to the Code of Federal Registration 21 CFR § 177.1520 Para (c) 3.1 and 3.2; wherein the quantity of hexane extractable material in a sample is determined gravimetrically.

### Neutron Activation Analysis (NAA)

Neutron Activation Analysis, hereafter NAA, was used to determine catalyst residues in polyethylene compositions and was performed as follows. A radiation vial (composed of ultrapure polyethylene, 7 mL internal volume) was filled with a polymer sample and the sample weight was recorded. Using a pneumatic transfer system the sample was placed inside a SLOWPOKE™ nuclear reactor (Atomic Energy of Canada Limited, Ottawa, Ontario, Canada) and irradiated for 30 to 600 seconds for short half-life elements (e.g., Ti, V. Al, Mg, and Cl) or 3 to 5 hours for long half-life elements (e.g., Zr, Hf, Cr, Fe and Ni). The average thermal neutron flux within the reactor was 5×10¹¹/cm²/s. After irradiation, samples were withdrawn from the reactor and aged, allowing the radioactivity to decay; short half-life elements were aged for 300 seconds or long half-life elements were aged for several days. After aging, the gamma-ray spectrum of the sample was recorded using a germanium semiconductor gamma-ray detector (Ortec model GEM55185, Advanced Measurement Technology Inc., Oak Ridge, Tenn., U.S.A.) and a multichannel analyzer (Ortec model DSPEC Pro). The amount of each element in the sample was calculated from the gamma-ray spectrum and recorded in parts per million relative to the total weight of the polymer sample. The N.A.A. system was calibrated with Specpure standards (1,000 ppm solutions of the desired element (greater than 99% pure)). One mL of solutions (elements of interest) were pipetted onto a 15 mm×800 mm rectangular paper filter and air dried. The filter paper was then placed in a 1.4 mL polyethylene irradiation vial and analyzed by the N.A.A. system. Standards are used to determine the sensitivity of the N.A.A. procedure (in counts/μg).

### Dynamic Mechanical Analysis (DMA)

Oscillatory shear measurements under small strain amplitudes were carried out to obtain linear viscoelastic functions at 190° C. under N₂ atmosphere, at a strain amplitude of 10% and over a frequency range of 0.02-126 rad/s at 5 points per decade. Frequency sweep experiments were performed with a TA Instruments DHR3 stress-controlled rheometer using cone-plate geometry with a cone angle of 5°, a truncation of 137 μm and a diameter of 25 mm. In this experiment a sinusoidal strain wave was applied and the stress response was analyzed in terms of linear viscoelastic functions. The zero shear rate viscosity (η₀) based on the DMA frequency sweep results was predicted by Ellis model (sec R. B. Bird et al. “Dynamics of Polymer Liquids. Volume 1: Fluid Mechanics” Wiley-Interscience Publications (1987) p. 228) or Carreau-Yasuda model (see K. Yasuda (1979) PhD Thesis, IT Cambridge). The dynamic rheological data were analyzed using the rheometer software (viz., Rheometrics RHIOS V4.4 or Orchestrator Software) to determine the melt elastic modulus G′(G″=500) at a reference melt viscous modulus (G″) value of G″=500 Pa. If necessary, the values were obtained by interpolation between the available data points using the Rheometrics software. The term “Storage modulus”, G′(co), also known as “elastic modulus”, which is a function of the applied oscillating frequency, co, is defined as the stress in phase with the strain in a sinusoidal deformation divided by the strain; while the term “Viscous modulus”, G″(ω), also known as “loss modulus”, which is also a function of the applied oscillating frequency, ω, is defined as the stress 90 degrees out of phase with the strain divided by the strain. Both these moduli, and the others linear viscoelastic, dynamic rheological parameters, are well known within the skill in the art, for example, as discussed by G. Marin in “Oscillatory Rheometry”, Chapter 10 of the book on Rheological Measurement, edited by A. A. Collyer and D. W. Clegg, Elsevier, 1988.

The shear thinning index, SHI_{(1,100)} was calculated as the ratio of the complex viscosities estimated at shear stress of 1 kPa over that estimated at a shear stress of 100 kPa. The shear thinning index, SHI_{(1,100)} provides information on the shear thinning behavior of the polymer melt. A high value indicates a strong dependence of viscosity with changes in deformation rate (shear or frequency).

The evaluation of relative elasticity is based on measurements carried out at low frequencies, which are most relevant for conditions associated with powder sintering and densification in rotomolding. The relative elasticity is evaluated based on the ratio of G′ over G″ at a frequency of 0.05 rad/s from DMA frequency sweep measurements carried out at 190° C. Data reported in the literature show that resin compositions with a high relative elasticity tend to exhibit processing difficulties in terms of slow powder densification. Wang and Kontopoulou (2004) reported adequate rotomoldability for blend compositions that were characterized with a relative elasticity as high as 0.125. In that study, the effect of plastomer content on the rotomoldability of polypropylene was investigated (W. Q. Wang and M. Kontopoulou (2004) Polymer Engineering and Science, vo. 44, no 9, pp 1662-1669). Further analysis of the results published by Wang and Kontopoulou show that compositions with higher plastomer content exhibited increasing relative elasticity (G′/G″>0.13) and correspondingly increasing difficulties in achieving full densification during rotomolding evaluation.

In this disclosure, the LCBF (Long Chain Branching Factor) was determined using the DMA determined η₀ (see U.S. Pat. No. 10,442,921).

### Melt Strength

The melt strength is measured on Rosand RH-7 capillary rheometer (barrel diameter=15 mm) with a flat die of 2-mm Diameter, L/D ratio 10:1 at 190° C. Pressure Transducer: 10,000 psi (68.95 MPa). Piston Speed: 5.33 mm/min. Haul-off Angle: 52°. Haul-off incremental speed: 50-80 m/min² or 65±15 m/min². A polymer melt is extruded through a capillary die under a constant rate and then the polymer strand is drawn at an increasing haul-off speed until it ruptures. The maximum steady value of the force in the plateau region of a force versus time curve is defined as the melt strength for the polymer. The melt strength stretch ratio is defined as the ratio of the velocity at pulley over the velocity at the exit of the die.

### Long Chain Branching Factor (LCBF)

The LCBF (dimensionless) was determined for the polyethylene composition using the method described in U.S. Pat. No. 10,442,921 which is incorporated herein by reference.

The long chain branching factor (the “LCBF”) calculation requires the polydispersity corrected Zero Shear Viscosity (ZSVc) and the short chain branching (the “SCB”) corrected Intrinsic Viscosity (IVc) as fully described in the following paragraphs.

The correction to the Zero Shear Viscosity, ZSVc, having dimensions of poise, was performed as shown in equation Eq. (1):

$${ZSV}_{c} = \frac{1.8389 \times {η}_{0}}{2.411 {0}^{L n ( P d )}} \qquad Eq . ( 1 )$$

where η₀, the zero shear viscosity (poise), was measured by DMA as described above; Pd was the dimensionless polydispersity (M_{w}/Mₙ) as measured using conventional GPC as described above and 1.8389 and 2.4110 are dimensionless constants.

The correction to the Intrinsic Viscosity, IVc, having dimensions of dL/g, was performed as shown in equation Eq. (2):

$${IV}_{c} = [ η ] + \frac{A \times SCB \times {M}_{v}^{0.725}}{1000000} \qquad Eq . ( 2 )$$

where the intrinsic viscosity [η] (dL/g) was measured using 3D-SEC described above; the SCB has dimensions of (CH₃#/1000C) and was determined using FTIR as described above; Mᵥ, the viscosity average molar mass (g/mole), was determined using 3D-SEC as described above, and A was a dimensionless constant that depends on the α-olefin in the ethylene/α-olefin copolymer sample, i.e. A was 2.1626, 1.9772 or 1.1398 for 1-octene, 1-hexene and 1-butene α-olefins, respectively. In the case of an ethylene homopolymer no correction is required for the Mark-Houwink constant, i.e. SCB is zero.

“Linear” ethylene copolymers (or linear ethylene homopolymers), which do not contain LCB or contain undetectable levels of LCB, fall on the Reference Line defined by Eq. (3).

Log(IV_{c})=0.2100×Log(ZSV_{c})−0.7879 Eq. (3)

The calculation of the LCBF was based on the Horizontal-Shift (Sₕ) and Vertical-Shift (Sᵥ) from the linear reference line, as defined by the following equations:

Sₕ=Log(ZSV_{c})−4.7619×Log(IV_{c})−3.7519 Eq.(4)

Sᵥ=0.2100×Log(ZSV_{c})−Log(IV_{c})−0.7879 Eq.(5).

In Eq. (4) and (5), it is required that ZSV_{c} and IV_{c} have dimensions of poise and dL/g, respectively. The Horizontal-Shift (Sₕ) was a shift in ZSV_{c} at constant Intrinsic Viscosity (IV_{c}), if one removes the Log function its physical meaning is apparent, i.e. a ratio of two Zero Shear Viscosities, the ZSV_{c} of the sample under test relative to the ZSV_{c} of a linear ethylene copolymer (or a linear ethylene homopolymer) having the same IV_{c}. The Horizontal-Shift (Sₕ) was dimensionless. The Vertical-Shift (Sᵥ) was a shift in IV_{c} at constant Zero Shear Viscosity (ZSV_{c}), if one removes the Log function its physical meaning is apparent, i.e. a ratio of two Intrinsic Viscosities, the IV_{c} of a linear ethylene copolymer (or a linear ethylene homopolymer) having the same ZSV_{c} relative to the IV_{c} of the sample under test. The Vertical-Shift (Sᵥ) was dimensionless.

The dimensionless Long Chain Branching Factor (LCBF) was defined by Eq. (6):

$$LCBF = \frac{{s}_{h} \times {s}_{v}}{2} \qquad Eq . ( 6 )$$

In an embodiment of the disclosure, ethylene polymers (e.g. polyethylene compositions) having LCB are characterized as having a LCBF ≥0.0010 (dimensionless); in contrast, ethylene polymers having no LCB (or undetectable LCB) are characterized by a LCBF of less than 0.0010 (dimensionless).

### Impact Properties

Izod impact performance was determined according to ASTM D256. Izod impact specimens were notched to promote a stress concentration point to induce a brittle, rather than ductile, break. Tensile impact performance was determined according to ASTM D1822.

### Tensile Properties

The following tensile properties were determined using ASTM D 638: elongation at yield (%), yield strength (MPa), ultimate elongation (%), ultimate strength (MPa) and 1 and 2% secant modulus (MPa).

### Flexural Properties

Flexural properties, i.e., 2% flexural secant modulus was determined using ASTM D790-10 (published in April 2010).

### Environmental Stress Crack Resistance, ESCR

Plaques molded from the polyethylene compositions were tested according to the following ASTM methods: Bent Strip Environmental Stress Crack Resistance (ESCR), ASTM D1693; ESCR test under the “B” conditions of ASTM D1693 (at a temperature of) 50° C.) were conducted using a 100% solution of IGEPAL CO-630 (nonylphenoxy poly(ethyleneoxy)ethanol, branched; having the formula: 4-(branched-C₉H₁₉)-phenyl-[OCH₂CH₂]ₙ—OH, wherein subscript n is 9-10) and using a 10% solution of IGEPAL CO-630. It will be recognized by skilled persons that the test using the 10% solution (“B₁₀”) is more severe than the test using the 100% solution (“B₁₀₀”); i.e. that Bio values are typically lower than B₁₀₀ values.

Plaques molded from the polyethylene compositions were tested according to the following ASTM methods: Bent Strip Environmental Stress Crack Resistance (ESCR), ASTM D1693; ESCR test under the “A” conditions of ASTM D1693 (at a temperature of) 50° C.) were conducted using a 100% solution of IGEPAL CO-630 (nonylphenoxy poly(ethyleneoxy)ethanol, branched having the formula: 4-(branched-C₉H₁₉)-phenyl-[OCH₂CH₂]ₙ—OH, wherein subscript n is 9-10) and using a 10% solution of IGEPAL CO-630. It will be recognized by skilled persons that the test using the 10% solution (“A₁₀”) is more severe than the test using the 100% solution (“A₁₀₀”); i.e. that Bio values are typically lower than A₁₀₀ values.

### Preparation of Polyethylene Composition

The polyethylene composition was made using either i) a mixed single site catalyst system in an “in-series” dual reactor solution polymerization process or ii) a mixed single site catalyst/multi-site catalyst system in an “in-series” dual reactor solution polymerization. As a result, the polyethylene composition comprised a first ethylene copolymer made with a first single site catalyst and a second ethylene copolymer made with a second and different single site catalyst or with a multi-site catalyst. An “in series” dual reactor, solution phase polymerization process, including one employing a mixed single site catalyst has been described in U.S. Pat. Appl. No. 10,442,921; an “in series” dual reactor, solution phase polymerization process, including one employing a mixed single site catalyst/multi-site catalyst has been described in U.S. Pat. Appl. Pub. No. 2018/0305531. Basically, in an “in-series” dual reactor system the exit stream from a first polymerization reactor (R1) flows directly into a second polymerization reactor (R2). The R1 pressure was from about 14 MPa to about 18 MPa; while R2 was operated at a lower pressure to facilitate continuous flow from R1 to R2. Both R1 and R2 were continuously stirred reactors (CSTR's) and were agitated to give conditions in which the reactor contents were well mixed. The process was operated continuously by feeding fresh process solvent, ethylene, 1-octene and hydrogen to the reactors and in the removal of product (note however, that 1-octene is only feed to the first reactor). Although no co-monomer is feed directly to the downstream second reactor, R2 an ethylene copolymer is nevertheless formed in second reactor due to the significant presence of un-reacted 1-octene flowing from the first reactor to the second reactor where it is copolymerized with ethylene. Methylpentane was used as the process solvent (a commercial blend of methylpentane isomers). The volume of the first CSTR reactor (R1) was 3.2 gallons (12 L), and the volume of the second CSTR reactor (R2) was 5.8 gallons (22 L). Monomer (ethylene) and comonomer (1-octene) were purified prior to addition to the reactor using conventional feed preparation systems (such as contact with various absorption media to remove impurities such as water, oxygen and polar contaminants). The reactor feeds were pumped to the reactors at the ratios shown in Table 1. Average residence times for the reactors are calculated by dividing average flow rates by reactor volume and is primarily influenced by the amount of solvent flowing through each reactor and the total amount of solvent flowing through the solution process.

In the first reactor, R1, the following single site catalyst components were used to prepare the first ethylene copolymer: diphenylmethylene(cyclopentadienyl)(2,7-di-t-butylfluorenyl)hafnium dimethide [(2,7-tBu₂Flu)Ph₂C(Cp)HfMe₂]; methylaluminoxane (MMAO-07); trityl tetrakis(pentafluoro-phenyl)borate (trityl borate), and 2,6-di-tert-butyl-4-cthylphenol (BHEB). Methylaluminoxane (MMAO-07) and 2,6-di-tert-butyl-4-ethylphenol are premixed in-line and then combined with diphenylmethylene(cyclopentadienyl)(2,7-di-t-butylfluorenyl)hafnium dimethide and trityl tetrakis(pentafluoro-phenyl)borate just before entering the polymerization reactor (R1). The efficiency of the single site catalyst formulation was optimized by adjusting the mole ratios of the catalyst components and the R1 catalyst inlet temperature (further details are provided in Table 1).

In the second reactor, R2, either a single site catalyst was used (Examples 1 and 2) or a Zielger-Natta catalyst was used (Examples 3 and 4).

For Examples 1 and 2, the following single site catalyst components were used to prepare the second ethylene copolymer in the second reactor, R2:

cyclopentadienyltri(tertiarybutyl)phosphinimine titanium dichloride, (Cp[(t-Bu)₃PN]TiCl₂); methylaluminoxane (MAO-07); trityl tetrakis(pentafluoro-phenyl)borate, and 2,6-di-tert-butyl-4-ethylphenol. Methylaluminoxane (MMAO-07) and 2,6-di-tert-butyl-4-ethylphenol are premixed in-line and then combined with cyclopentadienyltri(tertiarybutyl)phosphinimine titanium dichloride and trityl tetrakis(pentafluoro-phenyl)borate just before entering the polymerization reactor (R2). The efficiency of the single site catalyst formulation was optimized by adjusting the mole ratios of the catalyst components and the R2 catalyst inlet temperature (further details are provided in Table 1).

The solvents used for the single site catalyst component were as follows: methylpentane was used for the methylaluminoxane and the BHEB components; xylene was used for the active catalyst molecule (i.e. the metallocene and the phosphinimine catalysts) and the trityl borate components.

For Examples 3 and 4, the following Ziegler-Natta (ZN) catalyst components were used to prepare the second ethylene copolymer in the second reactor, R2: butyl ethyl magnesium; tertiary butyl chloride; titanium tetrachloride; diethyl aluminum ethoxide; and triethyl aluminum. Methylpentane was used as the catalyst component solvent and the in-line Ziegler-Natta catalyst formulation was prepared using the following steps and then injected into the second reactor (R2). In step one, a solution of tricthylaluminum and butyl ethyl magnesium (Mg:Al=20, mol:mol) was combined with a solution of tertiary butyl chloride and allowed to react for about 30 seconds to produce a MgCl₂ support. In step two, a solution of titanium tetrachloride was added to the mixture formed in step one and allowed to react for about 14 seconds prior to injection into second reactor (R2). The in-line Ziegler-Natta catalyst was activated in the reactor by injecting a solution of diethyl aluminum ethoxide into R2. The quantity of titanium tetrachloride added to the reactor is shown in Table 1. The efficiency of the in-line Ziegler-Natta catalyst formulation was optimized by adjusting the mole ratios of the catalyst components (further details are provided in Table 1).

Polymerization in the continuous solution polymerization process was terminated by adding a catalyst deactivator to the second reactor exit stream. The catalyst deactivator used was octanoic acid (caprylic acid), commercially available from P&G Chemicals, Cincinnati, OH, U.S.A. The catalyst deactivator was added such that the moles of fatty acid added were 50% of the total molar amount of hafnium, titanium and aluminum added to the polymerization process; to be clear, the moles of octanoic acid added=0.5×(moles hafnium+moles titanium+moles aluminum).

A two-stage devolatilization process was employed to recover the polyethylene composition from the process solvent, i.e. two vapor/liquid separators were used and the second bottom stream (from the second V/L separator) was passed through a gear pump/pelletizer combination. DHT-4V (hydrotalcite), supplied by Kyowa Chemical Industry Co. Ltd., Tokyo, Japan was used as a passivator, or acid scavenger, in the continuous solution process. A slurry of DHT-4V in process solvent was added prior to the first V/L separator.

Prior to pelletization the polyethylene composition was stabilized by adding about 500 ppm of IRGANOX 1076 (a primary antioxidant) and about 500 ppm of IRGAFOS 168 (a secondary antioxidant), based on weight of the polyethylene composition. Antioxidants were dissolved in process solvent and added between the first and second V/L separators.

Table 1 shows the reactor conditions used to make an inventive polyethylene compositions. Table 1 includes process parameters, such as the ethylene and 1-octene splits between the reactors (R1 and R2), the reactor temperatures, the ethylene conversions, etc.

TABLE 1
Polymerization Conditions

| | Example No. | | | |
|---|---|---|---|---|
| | Example 1 | Example 2 | Example 3 | Example 4 |
| | (Inventive) | (Inventive) | (Inventive) | (Inventive) |
| Catalyst in R1 | Metallocene | Metallocene | Metallocene | Metallocene |
| Catalyst in R2 | Phosphinimine | Phosphinimine | Ziegler | Ziegler |
| | | | Natta | Natta |
| Total Solution Rate (TSR) (kg/h) | 546 | 545.3 | 550.0 | 500.0 |
| Ethylene Concentration (wt % | 16.4 | 16.4 | 16.5 | 16.5 |
| overall) | | | | |
| 1-Octene to Ethylene Ratio Total | 0007 | 0.006 | 0.019 | 0.025 |
| Ethylene split between First | 0.30/0.70 | 0.30/0.70 | 0.30/0.70 | 0.30/0.70 |
| Reactor (R1) and Second | | | | |
| Reactor (R2) | | | | |
| 1-Octene split between First | 1/0 | 1/0 | 1/0 | 1/0 |
| Reactor (R1) and Second | | | | |
| Reactor (R2), | | | | |
| Ethylene Fresh Feed to R1 | 10.3 | 13.4 | 10.00 | 10.90 |
| Concentration (wt %) | | | | |
| 1-Octene to Ethylene Ratio in | 0.007 | 0.006 | 0.019 | 0.025 |
| R1 Fresh Feed (g/g) | | | | |
| Ethylene Fresh Feed to R2 | 22.130 | 18.200 | 22.870 | 21.160 |
| Concentration (wt %) | | | | |
| 1-Octene/Ethylene in Fresh Feed | 0 | 0 | 0 | 0 |
| to R2 (g/g) | | | | |
| Hydrogen in Reactor 1 (ppm) | 4.1 | 3.1 | 4.0 | 3.0 |
| Hydrogen in Reactor 2 (ppm) | 10.9 | 13.1 | 57.8 | 70.2 |
| Reactor 1 Inlet Temperature (° C.) | 25 | 25 | 25 | 25 |
| Reactor 2 Inlet Temperature (° C.) | 25 | 25 | 30 | 30 |
| Reactor 1 Temperature (° C.) | 134 | 163 | 133 | 143 |
| Reactor 2 Temperature (° C.) | 210 | 210 | 215 | 215 |
| Ethylene Conversion in | 80.3 | 80.0 | 80.3 | 80.0 |
| Reactor 1 (%) | | | | |
| Ethylene Conversion in | 82.0 | 81.9 | 95.0 | 95.1 |
| Reactor 2 (%) | | | | |
| Catalyst Feed in R1 | 0.68 | 0.84 | 0.19 | 0.22 |
| (SSC in ppm) | | | | |
| SSC Al/Hf in R1 (mol/mol) | 30 | 30 | 70.5 | 60.6 |
| SSC - BHEB/Al in R1 | 0.40 | 0.41 | 0.20 | 0.20 |
| (mol/mol) | | | | |
| SSC - B/Hf in R1 (mol/mol) | 1.20 | 1.20 | 1.66 | 1.53 |
| Catalyst Feed in R2 (SSC in | 0.30 | 0.35 | — | — |
| ppm) | | | | |
| SSC - Al/Ti in R2 (mol/mol) | 25 | 25 | — | — |
| SSC - BHEB/Al in R2 | 0.30 | 0.30 | — | — |
| (mol/mol) | | | | |
| SSC - B/Ti in R2 (mol/mol) | 1.20 | 1.20 | — | — |
| Catalyst Feed in R2 (Titanium | — | — | 4.8 | 4.7 |
| tetrachloride, TiCl₄ in ppm) | | | | |
| ZN - tert-tert-Butyl chloride/ | — | — | 2.0 | 2.0 |
| Butyl(ethyl)magnesium in R2 | | | | |
| (mol/mol) | | | | |
| ZN - Diethylaluminium ethoxide/ | — | — | 1.3 | 1.4 |
| TiCl₄ in R2 (mol/mol) | | | | |
| ZN - Triethylaluminium/TiCl₄ | — | — | 0.37 | 0.37 |
| in R2 (mol/mol) | | | | |
| ZN - Butyl(ethyl)magnesium/ | — | — | 7.4 | 7.4 |
| TiCl₄ in R2 (mol/mol) | | | | |
| Polyethylene Production Rate | 77.4 | 77.3 | 88.1 | 80.4 |
| (kg/h) | | | | |

The properties of a polyethylene composition produced according to the present disclosure, Examples 1˜4 are provided in Table 2. Table 2 also includes data for comparative polyethylene resins, Examples 5, 6 and 7.

The comparative compositions, Comp. Examples 5 and 6 were made in a dual reactor solution polymerization process and were made substantially as described in International Application No. PCT/IB2020/060056 and U.S. Provisional Pat. Appl. No. 62/929,304. During the production of Comp. Example 5 and 6 a mixed catalyst system was employed: a single site catalyst system employing a phosphinimine catalyst, Cp[(t-Bu)₃PN]TiCl₂, which is known not to produce long chain branching, was used in the first reactor and a Ziegler-Natta catalyst, which also is known not to produce long chain branching was used in the second reactor.

The comparative composition, Comp. Example 7 was made in a dual reactor solution polymerization process and was made substantially as described in U.S. Provisional Pat. Appl. No. 63/037,754. During the production of Comp. Example 7, a single site catalyst system employing a phosphinimine catalyst, Cp[(t-Bu)₃PN]TiCl₂, which is known not to produce long chain branching, was used in both the first reactor and the second reactor.

Table 3 includes further data describing the polyethylene compositions made according to the present invention, including further testing of plaques made from the compositions. Table 3 also includes data for comparative polyethylene resins.

TABLE 2
Polymer Properties

| | Example No. | | | |
|---|---|---|---|---|
| | Example 1 | Example 2 | Example 3 | Example 4 |
| | (Inventive) | (Inventive) | (Inventive) | (Inventive) |
| Density (g/cm³) | 0.9525 | 0.9549 | 0.9535 | 0.9529 |
| Melt Index I₂ (g/10 min) | 1.25 | 1.43 | 1.24 | 1.24 |
| Melt Index I₆ (g/10 min) | 11 | 11.1 | 7.22 | 8.62 |
| Melt Index I₁₀ (g/10 min) | | | | |
| Melt Index I₂₁ (g/10 min) | 134 | 136 | 76 | 108 |
| Melt Flow Ratio (I₂₁/I₂) | 90 | 91 | 62 | 87 |
| Stress Exponent | 1.82 | 1.83 | 1.61 | 1.77 |
| Melt Flow Ratio (I₁₀/I₂) | 15.5 | 16.8 | 12.5 | 16 |
| CTREF | | | | |
| High Temp. Elution Peak (° C.) | 96.4 | 96.4 | 98.7 | 98.2 |
| Low Temp. Elution Peak (° C.) | 95.4 | 95.6 | 91 | 88.8 |
| CDBI₅₀ | 86.3 | 84.8 | 42 | 38.4 |
| FTIR | | | | |
| Branch Freq/1000 C | 1.4 | 1.6 | 1.8 | 2.2 |
| Comonomer ID | 1-octene | 1-octene | 1-octene | 1-hexene |
| Comonomer Content (mole %) | 0.3 | 0.3 | 0.4 | 0.4 |
| Comonomer Content (wt %) | 1.1 | 1.2 | 1.4 | 1.7 |
| Internal Unsat/100 C | 0.008 | 0.01 | 0.001 | 0.001 |
| Side Chain Unsat/100 C | 0 | 0 | 0.001 | 0 |
| Terminal Unsat/100 C | 0.009 | 0.01 | 0.044 | 0.048 |
| GPC | | | | |
| Mₙ | 23,965 | 23,201 | 21,415 | 15,456 |
| M_{w} | 106,037 | 107,716 | 102,103 | 91,397 |
| M_{z} | 385,302 | 427,118 | 334,149 | 315,664 |
| Polydispersity Index (M_{w}/Mₙ) | 4.4 | 4.6 | 4.8 | 5.9 |
| M_{z}/M_{w} | 3.6 | 4.0 | 3.3 | 3.5 |
| Melt Strength | | | | |
| Mean Melt Strength - 190° C. | 3.8 | 3.3 | 3.5 | 3.5 |
| (CN) | | | | |
| Mean Stretch Ratio - 190° C. (%) | 411 | 384 | 706 | 476 |
| Rheo-Ro - Dynamic Frequency | | | | |
| Sweep | | | | |
| Zero Shear Viscosity - 190° C. | 21,170 | 39,620 | 19,190 | 30,090 |
| (Pa-s) | | | | |
| Relative elasticity G′/G″ | 0.35 | 0.47 | 0.30 | 0.43 |
| at 0.05 rad/s | | | | |
| Shear Thinning Index, SHI_{(1, 100)} | 15.7 | 34.0 | 11.4 | 22.4 |
| Hexane Extractables (%) - | 0.16 | | 0.05 | 0.43 |
| Plaque | | | | |
| Long Chain Branching Factor | 0.0349 | 0.0781 | 0.0298 | 0.0475 |
| by DMA and 3D-SEC | | | | |
| (LCBF) | | | | |
| Metal Residues | | | | |
| Ti (ppm) | 0.213 | 0.223 | 5.55 | 5.26 |
| Hf (ppm) | 0.514 | 0.476 | 0.105 | 0.093 |

| | Example No. | | |
|---|---|---|---|
| | Example 5 | Example 6 | Example 7 |
| | (Comparative) | (Comparative) | (Comparative) |
| Density (g/cm³) | 0.9538 | 0.9481 | 0.9514 |
| Melt Index I₂ (g/10 min) | 1.29 | 1.29 | 1.47 |
| Melt Index I₆ (g/10 min) | 6.06 | 6.81 | |
| Melt Index I₁₀ (g/10 min) | | | |
| Melt Index I₂₁ (g/10 min) | 53 | 68.2 | 67 |
| Melt Flow Ratio (I₂₁/I₂) | 40.9 | 52.9 | 45.7 |
| Stress Exponent | | | |
| Melt Flow Ratio (I₁₀/I₂) | | | |
| CTREF | | | |
| High Temp. Elution Peak (° C.) | 97 | 96.7 | 95.0 |
| Low Temp. Elution Peak (° C.) | | 93 | |
| CDBI₅₀ | 77.7 | 74.9 | 78.7 |
| FTIR | | | |
| Branch Freq/1000 C | 0.9 | 3.4 | 3.0 |
| Comonomer ID | 1-octene | 1-octene | 1-octene |
| Comonomer Content (mole %) | 0.2 | 0.7 | 0.6 |
| Comonomer Content (wt %) | 0.7 | 2.7 | |
| Internal Unsat/100 C | 0.001 | 0.001 | |
| Side Chain Unsat/100 C | 0.002 | 0.001 | |
| Terminal Unsat/100 C | 0.061 | 0.064 | |
| GPC | | | |
| Mₙ | 22,983 | 24,268 | 16,969 |
| M_{w} | 105,018 | 109,673 | 95,246 |
| M_{z} | 314,217 | 384,584 | 263,475 |
| Polydispersity Index (M_{w}/Mₙ) | 4.6 | 4.5 | 5.6 |
| M_{z}/M_{w} | 3.0 | 3.5 | 2.8 |
| Melt Strength | | | |
| Mean Melt Strength - 190° C. (CN) | 2.9 | | 1.8 |
| Mean Stretch Ratio - 190° C. (%) | 598 | | 658.5 |
| Rheo-Ro - Dynamic Frequency | | | |
| Sweep | | | |
| Zero Shear Viscosity - 190° C. (Pa-s) | 9,647 | | 7062 |
| Relative elasticity G′/G″ | 0.11 | | 0.06 |
| at 0.05 rad/s | | | |
| Shear Thinning Index, SHI_{(1, 100)} | 5.0 | | |
| Hexane Extractables (%) - Plaque | 0.16 | 0.21 | |
| Long Chain Branching Factor | 0.000523 | | |
| by DMA and 3D-SEC (LCBF) | | | |
| Metal Residues | | | |
| Ti (ppm) | 5.37 | | |
| Hf (ppm) | <0.01 | | |

TABLE 3
Plaque Properties

| | Example No. | | | |
|---|---|---|---|---|
| | Example 1 | Example 2 | Example 3 | Example 4 |
| | (Inventive) | (Inventive) | (Inventive) | (Inventive) |
| Tensile Properties | | | | |
| Tensile Stress - Yield; MPa | 29.3 | 30.1 | 27.4 | 27.8 |
| Tensile Stress - Break; MPa | 19 | 19.9 | | |
| Tensile Secant Modulus - 1%; | 1382 | 1390 | 1344.3 | 1366.9 |
| MPa | | | | |
| Tensile Elongation - Yield; % | 9 | 9 | 9 | 8 |
| Tensile Elongation - Break; % | 712 | 778 | 712 | 691 |
| Flexural Properties | | | | |
| Flexural Secant Modulus - | 1306 | 1308 | 1284 | 1296 |
| 1%; MPa | | | | |
| Flexural; Stress - Yield; MPa | 39.6 | 39.9 | 38.9 | 39.2 |
| Impact Properties | | | | |
| Izod Impact (ft-lb/in) | 2.2 | 1.9 | 4.5 | 3.4 |
| Tensile Impact (ft-lb/in²) | 143.3 | 115.6 | 222.5 | 262 |
| ESCR | | | | |
| ESCR Cond. A at 10% | 158 | 85 | ≥814 | ≥1172 |
| CO630 (hrs) | | | | |
| ESCR Cond. A at 100% | 424 | >1173 | ≥1172 | ≥1172 |
| CO630 (hrs) | | | | |
| ESCR Cond. B at 10% | 68 | 64 | 439 | ≥800 |
| CO630 (hrs) | | | | |
| ESCR Cond. B at 100% | 411 | >1173 | ≥1174 | ≥1173 |
| CO630 (hrs) | | | | |

| | Example No. | | |
|---|---|---|---|
| | Example 5 | Example 6 | Example 7 |
| | (Comparative) | (Comparative) | (Comparative) |
| Tensile Properties | | | |
| Tensile Stress - Yield; MPa | 28.2 | | |
| Tensile Stress - Break; MPa | | | |
| Tensile Secant Modulus - 1%; MPa | 1293 | | |
| Tensile Elongation - Yield; % | 9 | | |
| Tensile Elongation - Break; % | 792 | | |
| Flexural Properties | | | |
| Flexural Secant Modulus - 1%; MPa | 1271 | | 1159 |
| Flexural; Stress - Yield; MPa | 37.6 | | |
| Impact Properties | | | |
| Izod Impact (ft-lb/in) | 3.5 | 6.7 | 1.9 |
| Tensile Impact (ft-lb/in²) | 187.1 | 146.2 | 228.6 |
| ESCR | | | |
| ESCR Cond. A at 10% CO630 (hrs) | 99-163 | | 151 |
| ESCR Cond. A at 100% CO630 (hrs) | >1000 | >1000 | 144 |
| ESCR Cond. B at 10% CO630 (hrs) | 92 | 343 | >1000 |
| ESCR Cond. B at 100% CO630 (hrs) | 556 | >1000 | >1000 |

### Polyethylene Composition Deconvolution

Mathematical deconvolutions were performed to determine the relative amounts of each of the first and second ethylene copolymers present in a polyethylene composition, as well as the molecular weights (M_{w}, Mₙ, M_{z}), and comonomer content (the SCB frequency per 1000 polymer backbone carbon atoms) of each of the first and second ethylene copolymers made in the first and second reactors (R1, and R2).

For the deconvolution calculations it was assumed that the single-site catalyzed ethylene copolymer components follow a Flory molecular weight distribution function and they have a homogeneous comonomer distribution across the whole molecular weight range.

Estimates were first obtained from predictions obtained using fundamental kinetic models with kinetic constants specific for each catalyst formulation as well as feed and reactor conditions. The simulation was based on the configuration of a solution pilot plant as described above and which was used to produce the polyethylene compositions disclosed herein. The kinetic model predictions were used to establish estimates of the short chain branching distribution within the first and second ethylene copolymer components. The estimated values for short branches content were also validated against experimental results obtained from GPC-FTIR for the comonomer distribution. The fit between the simulated molecular weight distribution profile and the actual data obtained from GPC chromatography was improved by modeling the molecular weight distribution as a sum of components which have molecular weight distributions described using multiple-site idealized Flory distributions. For the deconvolutions, it was assumed that the single-site catalyzed polymer components follow a Flory molecular weight distribution function with a homogeneous comonomer distribution across the whole molecular weight range; the components made using a Ziegler-Natta catalyst were modeled using four (a four-mode) idealized Flory distributions. During the deconvolution, the overall Mn, Mw and Mz are calculated using the following relationships: Mn=1/Σ(wᵢ/(Mn)ᵢ), Mw=Σ(wᵢ×(Mw)ᵢ), Mz=Σ(wᵢ×(Mz)ᵢ²/Σ(wᵢ×(Mzᵢ) where i represents the i-th component and wi represents the relative weight fraction of the i-th component in the composition.

The following equations were used to calculate the densities and melt index, 12 of each ethylene copolymer component:

$${ρ}_{1} = 0.978863 - 5.94808 \times 1 {0}^{- 3} {( \frac{SCB}{1000 C} )}^{0.65} - 3. 8 \; 3133 \times {{10}^{- 4} [ {log}_{10} ( {M}_{n} ) ]}^{3} - 5.77986 \times 1 {0}^{- 6} {( \frac{{M}_{w}}{{M}_{n}} )}^{3} + 5.57395 \times 1 {0}^{- 3} {( \frac{{M}_{z}}{{M}_{w}} )}^{0.25} \qquad Equation ( 7 )$$

$${ρ}_{2} = ( ρ - {w}_{1} {ρ}_{1} ) / {w}_{2} \qquad Equation ( 8 )$$

$${log}_{10} ( Melt Index {I}_{2} ) = 7.9 - 3.909 [ {log}_{10} ( \frac{{M}_{w}}{1000} ) ] - 0.2799 {( \frac{{M}_{w}}{{M}_{n}} )}^{- 1} \qquad Equation ( 9 )$$

where Mn, Mw, Mz, and SCB/1000C are the deconvoluted values of the individual ethylene polymer components, as obtained from the results of the deconvolution described above, while p is the density of the overall polyethylene composition and is determined experimentally. Equations (1) and (2) were used to estimate p1 and p2, the density of the first and second ethylene copolymers, respectively. Equation (3) was used to estimate the melt index, I₂ of the first and second ethylene copolymers, respectively. See for example, Alfred Rudin, in The Elements of Polymer Science and Engineering, 2nd edition, Academic Press, 1999 and U.S. Pat. No. 8,022,143. The deconvolution results are provided in Table 4.

TABLE 4
Polymer Deconvolution

| | Example No. | | |
|---|---|---|---|
| | Example 1 | Example 2 | Example 3 |
| | (Inventive) | (Inventive) | (Inventive) |
| The First Ethylene Copolymer | | | |
| (Deconvolution) | | | |
| Catalyst | SSC | SSC | SSC |
| | (metallocene) | (metallocene) | (metallocene) |
| Weight Fraction (%) | 27% | 27% | 25% |
| Mₙ | 132,192 | 131,398 | 132,957 |
| M_{w} | 264,384 | 262,797 | 265,914 |
| M_{z} | 396,576 | 394,196 | 398,872 |
| Polydispersity Index (M_{w}/Mₙ) | 2.0 | 2.0 | 2.0 |
| Branch Freq/1000 C (SCB1) | 2.8 | 2.1 | 6.6 |
| Density Estimate (g/cm³) | 0.9220 | 0.9239 | 0.9132 |
| Melt Index I₂ Estimate (g/10 min) | 0.02 | 0.02 | 0.02 |
| The Second Ethylene Copolymer | | | |
| (Deconvolution) | | | |
| Catalyst | SSC | SSC | Ziegler Natta |
| | (phosphinimine) | (phosphinimine) | |
| Weight Fraction (%) | 73% | 73% | 75% |
| Mₙ | 16,999 | 15,723 | 15,384 |
| M_{w} | 33,998 | 31,446 | 41,902 |
| M_{z} | 50,997 | 47,169 | 81,316 |
| Polydispersity Index (M_{w}/Mₙ) | 2.0 | 2.0 | 2.7 |
| Branch Freq/1000 C (SCB2) | 0.1 | 0.1 | 0.3 |
| Density Estimate (g/cm³) | 0.9641 | 0.9665 | 0.9668 |
| Melt Index I₂ Estimate (g/10 min) | 59 | 81 | 29 |
| SCB1/SCB 2 | 28 | 21 | 22 |

| | Example No. | | |
|---|---|---|---|
| | Example 4 | Example 5 | Example 6 |
| | (Inventive) | (Comparative) | (Comparative) |
| The First Ethylene Copolymer | | | Note 1 |
| (Deconvolution) | | | |
| Catalyst | SSC | SSC | SSC |
| | (metallocene) | (phosphinimine) | (phosphinimine) |
| Weight Fraction (%) | 23% | 20% | 21% |
| Mₙ | 134,965 | 161,500 | 178,377 |
| M_{w} | 269,929 | 323,000 | 356,754 |
| M_{z} | 404,894 | 484,500 | 535,131 |
| Polydispersity Index (M_{w}/Mₙ) | 2.0 | 2.0 | 2.0 |
| Branch Freq/1000 C (SCB1) | 7.8 | 1.9 | 2.4 |
| Density Estimate (g/cm³) | 0.9107 | 0.9218 | 0.9191 |
| Melt Index I₂ Estimate (g/10 min) | 0.02 | 0.009 | 0.006 |
| The Second Ethylene Copolymer | | | Note 1 |
| (Deconvolution) | | | |
| Catalyst | Ziegler Natta | Ziegler Natta | Ziegler Natta |
| Weight Fraction (%) | 77% | 80% | 79% |
| Mₙ | 12,914 | 19,200 | 18,839 |
| M_{w} | 35,512 | 58,500 | 51,676 |
| M_{z} | 70,035 | 123,600 | 110,475 |
| Polydispersity Index (M_{w}/Mₙ) | 2.7 | 3.0 | 2.7 |
| Branch Freq/1000 C (SCB2) | 0.4 | 0.6 | 0.4 |
| Density Estimate (g/cm³) | 0.9658 | 0.9618 | 0.9559 |
| Melt Index I₂ Estimate (g/10 min) | 55 | 8.0 | 12.6 |
| SCB1/SCB 2 | 19.5 | 3.2 | 6.0 |

Note 1:
The data provided in the Table 4, for Example 6 (Comparative) was determined using a polymerization process model, as outlined in International Application No. PCT/IB2020/060056 and U.S. Provisional Pat. Appl. No. 62/929,304.

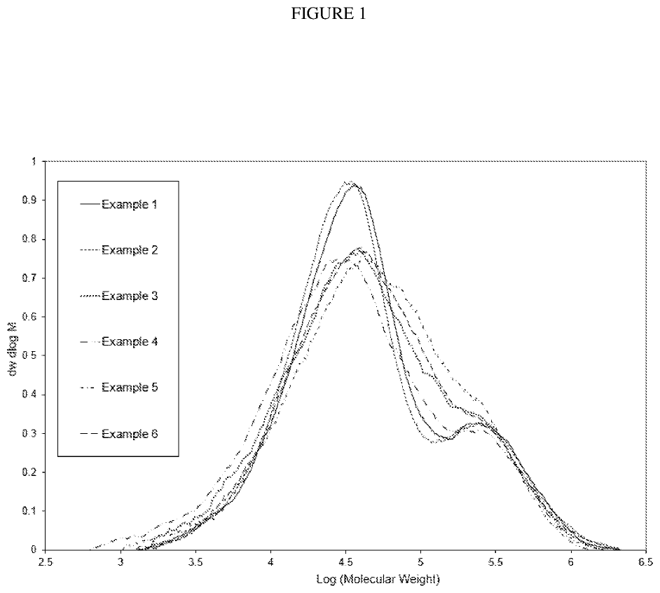

FIG. 1 shows that the polyethylene compositions of the present disclosure (Inv. Examples 1-4) have a bimodal GPC profile.

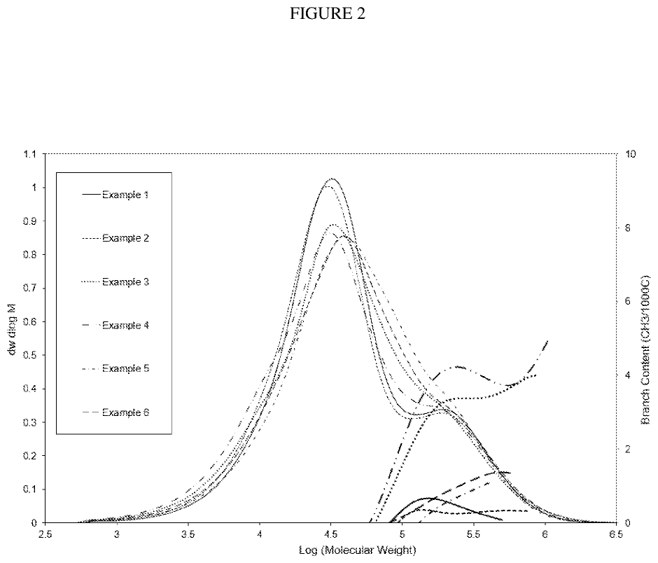

FIG. 2 shows that the polyethylene compositions of the present disclosure (Inv. Examples 1-4) have a bimodal GPC profile and either an increasing amount of comonomer as molecular weight increases or an initially increasing comonomer content and then a decreasing amount of comonomer as molecular weight increases. (as indicated by the short chain branching content, SCB/1000 backbone carbons atoms). Hence, the comonomer distribution of the Inventive Example 3, can be said to be reversed, while the comonomer distribution of Inventive Examples 1, 2 and 4 can be said to be partially reversed. FIG. 2 shows that the comparative resins (Comp Examples 5 and 6) have bimodal GPC profiles and have comonomer distributions which are reverse.

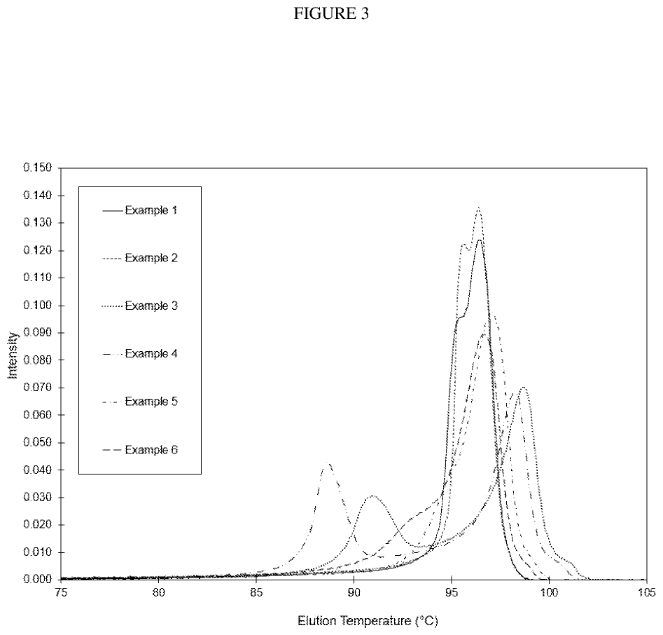

FIG. 3 presents the temperature rising elution fractionation (TREF) profile for polyethylene compositions made according to the present disclosure as well as for various comparative resins. Examples 1 and 2 have narrower profiles as compared to other examples, suggesting greater uniformity in their composition. Examples 3 and 4, on the other hand, show a more significant separation between elution peaks, which suggest important differences between the high and the low density components and which is consistent with results obtained from GPC-FTIR.

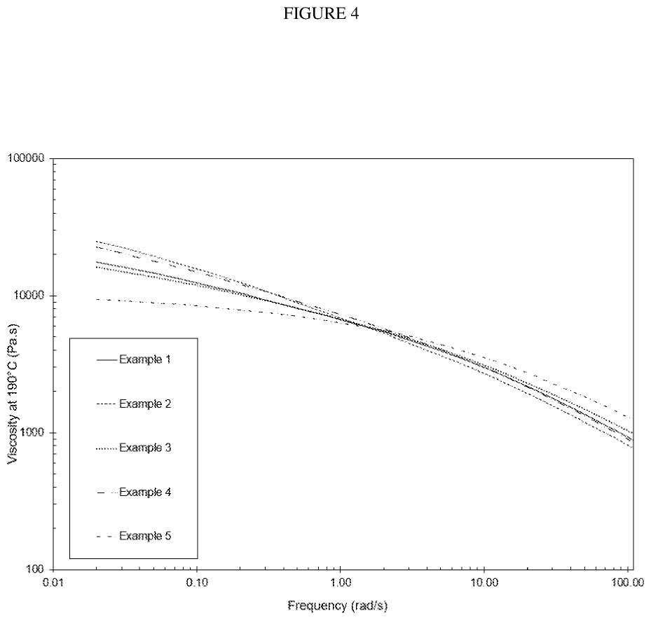

FIG. 4 presents the viscosity profiles from DMA frequency sweep experiments carried out at 190ºC for the polyethylene composition of the present disclosure as well as for a comparative resin. While all the examples have fairly similar molecular weight distributions (e.g. the Mw/Mn for all the examples are with a range of from 4.4 to 5.9), the rheological behavior of Inv. Examples 1-4 differs from that of Comp. Example 5. Without wishing to be bound by theory, the shape of the viscosity profile, in particular the reduction in viscosity with the increasing rate of deformation will have a strong influence on the flow distribution and melt pressure requirements during extrusion and molding applications. FIG. 4 clearly demonstrates that Examples 1, 2, 3 and 4 which are inventive show better shear thinning behavior than Examples 5 which is comparative, because their viscosity decreases more as the shear rate increases. This better shear thinning behavior is also evident from the higher shear thinning index observed for Inv. Examples 1, 2, 3 and 4, relative to Comparative Examples 5 (see Table 2): the SHI_{(1,100)} for each of Inv. Examples 1-4 was above 10, while for Comp. Example 5, the SHI_{(1,100)} was about 5.0. Without wishing to be bound by theory, the difference in shear thinning behavior is thought to be due to the presence of long chain branches in Examples 1, 2, 3 and 4. Good shear thinning behavior can be advantageous in applications that are extrusion-rate limited, as well as in mold-filling applications that usually require a resin with high flow characteristics. For resins with comparable molecular weights and molecular weight distributions, a lower viscosity at higher deformation rates means the resin will be easier to process, requiring lower temperature and extruder torque to achieve high throughput through a die. Similarly, resins with good shear thinning behavior will require lower melt pressures and temperatures to fill a mold cavity. Lower viscosity can be achieved with a reduction in molecular weight but often comes at the expense of mechanical performance. As the data in Table 3 and FIG. 4 shows, the polyethylene compositions of the present disclosure (Inv. Examples 1-4) have both good mechanical performance properties typically associated with relatively high molecular weights (e.g. Izod impact, ESCR) while also having high flow performance properties (e.g. lower viscosities at higher shear rates).

As can be seen from the data provided in Tables 2 and 3, the polyethylene compositions of the present disclosure (Inv. Example 1-4) have a good combination of flexural secant modulus at 1% (of greater than about 1200 MPa), good melt strength (above 3.0 cN), and good ESCR (an ESCR of greater than 400 hours in 100% IGEPAL under conditions A or B for Inv. Example 1, and an ESCR of greater than 1000 hours in 100% IGEPAL under conditions A or B for Inv. Examples 2, 3 and 4). This balance of stiffness, melt strength and environmental stress crack resistance is achieved, even though the compositions of the present disclosure generally have a relatively high density (e.g. ≥0.945 g/cm³). Inv. Examples 3 and 4, in particular, also have a good Izod Impact values (>3.0 foot.pound/inch). In addition, the higher melt flow ratio (I₂₁/I₂) observed for the Inv. Examples 1-4, relative to Comp. Examples 5 and 6, may facilitate polymer processing and article formation, by increasing polymer extrusion rates and/or by facilitating the injection molding of narrow mold cavities.

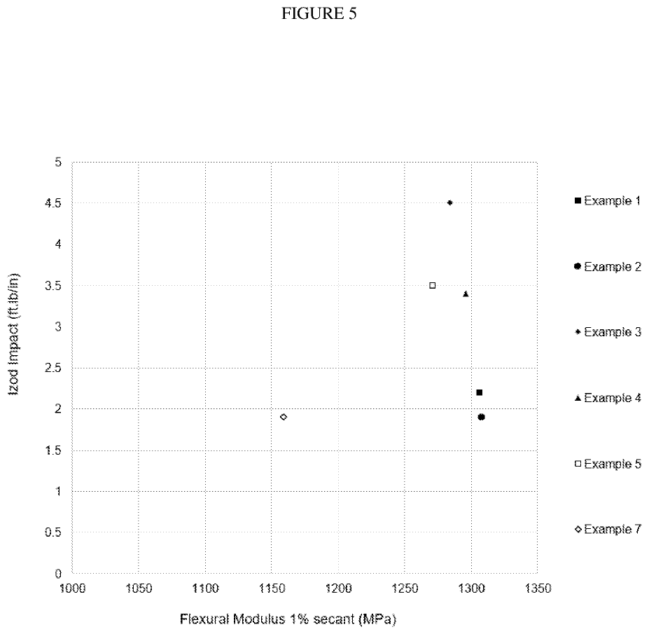

FIG. 5 further illustrates the relationship between the toughness (Izod impact) and stiffness (flexural secant modulus 1%) for Inventive Examples 1˜4 and for Comparative Examples 5 and 7. The plot shows that the polyethylene compositions of the present disclosure had good stiffness in combination with decent impact resistance properties. A particularly good balance of high stiffness and impact resistance was observed for Inv. Examples 3 and 4. Without wishing to be bound by theory, the combination of high Izod impact performance with high stiffness (e.g. flexural modulus) may be important when designing molded articles.

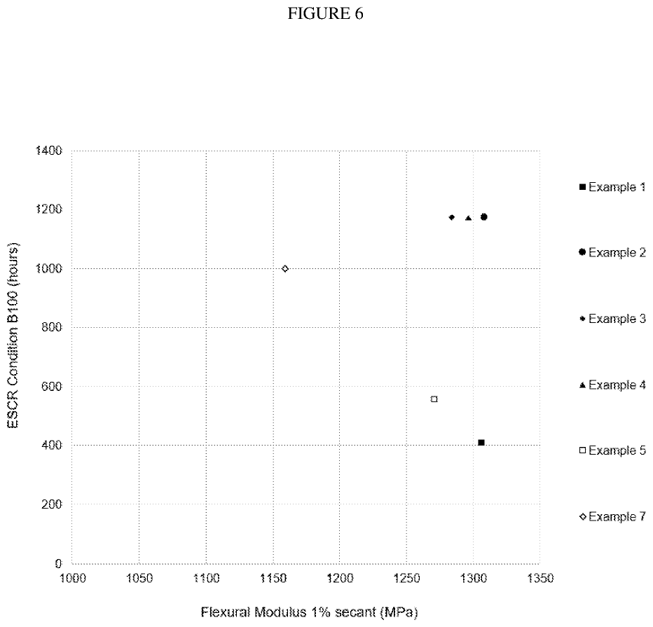

FIG. 6 further illustrates the relationship between the ESCR and the stiffness (flexural secant modulus 1%) for Inventive Examples 1˜4 and for Comparative Examples 5 and 7. The plot shows that the polyethylene compositions of the present disclosure had a similar or a superior balance of ESCR and stiffness relative to Comp. Examples 5 and 7, which are polyethylene resins having slightly lower density.

In view of the data in Table 2, as well as the data presented in FIGS. 5 and 6, a person skilled in the art will appreciate that the polyethylene compositions of the present disclosure provide a good balance of properties, including good melt strength, high stiffness (e.g. flexural secant modulus), reasonable impact properties (e.g. Izod and Tensile Impact), and good environmental stress crack resistance.

Non-limiting embodiments of the present disclosure include the following:

Embodiment A. A polyethylene composition comprising:
(i) from 5 to 50 weight % of first ethylene copolymer having a weight average molecular weight, Mw of >200,000 g/mol; and
(ii) from 95 to 50 weight % of a second ethylene copolymer;
wherein the first ethylene copolymer has a higher weight average molecular weight, Mw than the second ethylene copolymer;
wherein the first ethylene copolymer has a higher number of short chain branches per 1000 carbon atoms (SCB1) than the second ethylene copolymer (SCB2);
wherein the polyethylene composition has a density of ≥0.945 g/cm³; a melt index, I₂ of from 0.8 to 4.0 g/10 min; a melt flow ratio, I₂₁/I₂ of ≥50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; and an environmental stress crack resistance, ESCR of greater than 400 hours as determined by ASTM D1693 in 100% IGEPAL CO-630 under conditions A and B.

Embodiment B. The polyethylene composition of Embodiment A wherein the polyethylene composition has a density of from 0.948 g/cm³ to 0.957 g/cm³.

Embodiment C. The polyethylene composition of Embodiment A or B wherein the polyethylene composition has a melt index, I₂ of from 1.0 to 2.5 g/10 min.

Embodiment D. The polyethylene composition of Embodiment A, B, or C wherein the polyethylene composition has a melt flow ratio, I₂₁/I₂ of from 60 to 130.

Embodiment E. The polyethylene composition of Embodiment A, B, C, or D wherein the polyethylene composition has a molecular weight distribution, Mw/Mn of from 3.0 to 6.0.

Embodiment F. The polyethylene composition of Embodiment A, B, C, D, or E wherein the polyethylene composition has a Z-average molecular weight distribution, Mz/Mw of from 3.0 to 5.0.

Embodiment G. The polyethylene composition of Embodiment A, B, C, D, E, or F wherein the polyethylene composition has a Z-average molecular weight, Mz of from 250,000 g/mol to 550,000 g/mol.

Embodiment H. The polyethylene composition of Embodiment A, B, C, D, E, F, or G wherein the polyethylene composition has a composition distribution breadth index, CDBI₅₀ of <50%.

Embodiment I. The polyethylene composition of Embodiment A, B, C, D, E, F, or G wherein the polyethylene composition has a composition distribution breadth index, CDBI₅₀ of >60%.

Embodiment J. The polyethylene composition of Embodiment A, B, C, D, E, F, G, H, or I wherein the first ethylene copolymer has >2 short chain branches per 1000 carbon atoms (SCB1/1000 Cs).

Embodiment K. The polyethylene composition of Embodiment A, B, C, D, E, F, G, H, or I wherein the first ethylene has >5 short chain branches per 1000 carbon atoms (SCB1/1000 Cs).

Embodiment L. The polyethylene composition of Embodiment A, B, C, D, E, F, G, H, I, J, or K wherein the first ethylene copolymer has a density of from 0.910 to 0.932 gcm³.

Embodiment M. The polyethylene composition of Embodiment A, B, C, D, E, F, G, H, I, J. K. or L wherein the second ethylene copolymer has a density of from 0.950 to 0.970 gcm³.

Embodiment N. The polyethylene composition of Embodiment A, B, C, D, E, F, G, H, I, J, K. L, or M wherein the first ethylene copolymer has a melt index, I₂ of <0.5 g/10 min.

Embodiment O. The polyethylene composition of Embodiment A, B, C, D, E, F, G, H, I, J, K, L, M, or N wherein the second ethylene copolymer has a melt index, I₂ of >10.0 g/10 min.

Embodiment P. The polyethylene composition of Embodiment A, B, C, D, E, F, G, H, I, J, K, L, M, N, or O wherein the ratio of the number of short chain branches per 1000 carbon atoms (SCB1/1000 Cs) in the first ethylene copolymer to the number of short chain branches per 1000 carbon atoms (SCB2/1000 Cs) in the second ethylene copolymer is >10.

Embodiment Q. The polyethylene composition of Embodiment A, B, C, D, E, F, G, H, I, J, K, L, M, N, O, or P wherein first ethylene copolymer is made with a single site catalyst.

Embodiment R. The polyethylene composition of Embodiment A, B, C, D, E, F, G, H, I, J, K, L, M, N, O, P, or Q wherein the second ethylene copolymer made with a single site catalyst or a Ziegler-Natta catalyst.

Embodiment S. The polyethylene composition of Embodiment A, B, C, D, E, F, G, H, I, J, K, L, M, N, O, P, Q, or R wherein the polyethylene composition has hafnium residues present in at least 0.050 ppm based on the weight of the polyethylene composition.

Embodiment T. The polyethylene composition of Embodiment A, B, C, D, E, F, G, H, I, J, K, L, M, N, O, P, Q, R, or S wherein the polyethylene composition has a long chain branching factor, LCBF of >0.0050.

Embodiment U. The polyethylene composition of Embodiment A, B, C, D, E, F, G, H, I, J, K, L, M, N, O, P, Q, R, S, or T wherein the polyethylene composition has a shear thinning index. SHI_{(1,100)} of ≥7.5.

Embodiment V. The polyethylene composition of Embodiment A, B, C, D, E, F, G, H, I, J, K, L, M, N, O, P, Q, R, S, or T wherein the polyethylene composition has a shear thinning index, SHI_{(1,100)} of ≥10.0.

Embodiment W. The polyethylene composition of Embodiment A, B, C, D, E, F, G, H, I, J, K, L, M, N, O, P, Q, R, S, T, U, or V wherein the polyethylene composition has a relative elasticity, G′/G″ at 0.05 rad/s of ≤0.50.

Embodiment X. The polyethylene composition of Embodiment A, B, C, D, E, F, G, H, I, J, K, L, M, N, O, P, Q, R, S, T, U, V, or W wherein the polyethylene composition has Izod impact strength of >1.5 foot pounds per inch.

Embodiment Y. The polyethylene composition of Embodiment A, B, C, D, E, F, G, H, I, J, K, L, M, N, O, P, Q, R, S, T, U, V, W, or X wherein the polyethylene composition has a melt strength of ≥3.0 cN.

Embodiment Z. The polyethylene composition of Embodiment A, B, C, D, E, F, G, H, I, J, K, L, M, N, O, P, Q, R, S, T, U, V, W, X, or Y wherein the polyethylene composition has an environmental stress crack resistance, ESCR of greater than 1000 hours as determined by ASTM D1693 in 100% IGEPAL CO-630 under conditions A and B.

Embodiment AA. The polyethylene composition of Embodiment A, B, C, D, E, F, G, H, I, J, K, L, M, N, O, P, Q, R, S, T, U, V, W, X, Y, or Z wherein the polyethylene composition has flexural secant modulus at 1% of ≥1000 Mpa.

Embodiment BB. A polyethylene composition comprising:
(i) from 5 to 50 weight % of first ethylene copolymer having a weight average molecular weight, M_{w} of >200,000 g/mol; and
(ii) from 95 to 50 weight % of a second ethylene copolymer;
wherein the first ethylene copolymer has a higher weight average molecular weight, M_{w} than the second ethylene copolymer;
wherein the first ethylene copolymer has a higher number of short chain branches per 1000 carbon atoms (SCB1) than the second ethylene copolymer (SCB2);
wherein the polyethylene composition has a density of ≥0.945 g/cm³; a melt index. I₂ of from 0.8 to 4.0 g/10 min; a melt flow ratio, I₂₁/I₂ of ≥50; a molecular weight distribution, M_{w}/Mₙ of <6.5; a Z-average molecular weight, M_{z} of ≥250,000 g/mol; a Z-average molecular weight distribution, M_{z}/M_{w} of >2.5; a long chain branching factor, LCBF of >0.0010; a composition distribution breadth index, CDBI₅₀ of <50%; an Izod impact strength of >3.0 foot pounds per inch; and an environmental stress crack resistance, ESCR of greater than 1000 hours as determined by ASTM D1693 in 100% IGEPAL CO-630 under conditions A and B.

Embodiment CC. A polyethylene composition comprising:
(i) from 5 to 50 weight % of first ethylene copolymer having a weight average molecular weight, Mw of >200,000 g/mol; and
(ii) from 95 to 50 weight % of a second ethylene copolymer;
wherein the first ethylene copolymer has a higher weight average molecular weight, Mw than the second ethylene copolymer;
wherein the first ethylene copolymer has a higher number of short chain branches per 1000 carbon atoms (SCB1) than the second ethylene copolymer (SCB2);
wherein the polyethylene composition has a density of ≥0.945 g/cm³; a melt index, I₂ of from 0.8 to 4.0 g/10 min; a melt flow ratio, I₂₁/I₂ of ≥50; a molecular weight distribution, Mw/Mn of <6.5; a Z-average molecular weight, Mz of ≥250,000 g/mol; a Z-average molecular weight distribution, Mz/Mw of >2.5; a long chain branching factor, LCBF of >0.0010; a composition distribution breadth index, CDBI₅₀ of >60%; an Izod impact strength of >1.5 foot pounds per inch; and an environmental stress crack resistance, ESCR of greater than 400 hours as determined by ASTM D1693 in 100% IGEPAL CO-630 under conditions A and B.

Embodiment DD. A cap or closure prepared from the polyethylene composition of Embodiment A, B, C, D, E, F, G, H, I, J, K, L, M, N, O, P, Q, R, S, T, U, V, W, X, Y, Z, AA, BB, or CC.

Embodiment EE. A rotomolded article prepared from the polyethylene composition of Embodiment A, B, C, D, E, F, G, H, I, J, K, L, M, N, O, P, Q, R, S, T, U, V, W, X, Y, Z, AA, BB, or CC.

Embodiment FF. A foamed article prepared from the polyethylene composition of Embodiment A, B, C, D, E, F, G, H, I, J, K, L, M, N, O, P, Q, R, S, T, U, V, W, X, Y, Z, AA, BB, or CC.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

### INDUSTRIAL APPLICABILITY

High density polyethylene compositions are provided which have high melt strength, good impact resistance (Izod), and good environmental stress crack resistance (ESCR). The polyethylene compositions may be suitable for use in the manufacture of molded articles.

1. A polyethylene composition comprising:
(i) from 5 to 50 weight % of first ethylene copolymer having a weight average molecular weight, Mw of >200,000 g/mol; and
(ii) from 95 to 50 weight % of a second ethylene copolymer;
wherein the first ethylene copolymer has a higher weight average molecular weight, Mw, than the second ethylene copolymer;
wherein the first ethylene copolymer has a higher number of short chain branches per 1000 carbon atoms (SCB1) than the second ethylene copolymer (SCB2);
wherein the polyethylene composition has a density of ≥0.945 g/cm³; a melt index, I₂ of from 0.8 to 4.0 g/10 min; a melt flow ratio, I₂₁/I₂ of ≥50; a molecular weight distribution, Mw/Mn of <6.5; a Z-average molecular weight, Mz of ≥250,000 g/mol; a Z-average molecular weight distribution, Mz/Mw, of >2.5; a long chain branching factor, LCBF of >0.0010; and an environmental stress crack resistance, ESCR, of greater than 400 hours as determined by ASTM D1693 in 100% IGEPAL CO-630 under conditions A and B.

2. The polyethylene composition of claim 1, wherein the polyethylene composition has a density of from 0.948 g/cm³ to 0.957 g/cm³.

3. The polyethylene composition of claim 1, wherein the polyethylene composition has a melt index, I₂, of from 1.0 to 2.5 g/10 min.

4. The polyethylene composition of claim 1, wherein the polyethylene composition has a melt flow ratio, I₂₁/I₂, of from 60 to 130.

5. The polyethylene composition of claim 1, wherein the polyethylene composition has a molecular weight distribution, Mw/Mn, of from 3.0 to 6.0.

6. The polyethylene composition of claim 1, wherein the polyethylene composition has a Z-average molecular weight distribution, Mz/Mw, of from 3.0 to 5.0.

7. The polyethylene composition of claim 1, wherein the polyethylene composition has a Z-average molecular weight, Mz, of from 250,000 g/mol to 550,000 g/mol.

8. The polyethylene composition of claim 1, wherein the polyethylene composition has a composition distribution breadth index, CDBI₅₀, of <50%.

9. The polyethylene composition of claim 1, wherein the polyethylene composition has a composition distribution breadth index, CDBI₅₀, of >60%.

10. The polyethylene composition of claim 1, wherein the first ethylene copolymer has >2 short chain branches per 1000 carbon atoms (SCB1/1000 Cs).

11. The polyethylene composition of claim 1, wherein the first ethylene has >5 short chain branches per 1000 carbon atoms (SCB1/1000 Cs).

12. The polyethylene composition of claim 1, wherein the first ethylene copolymer has a density of from 0.910 to 0.932 g/cm³.

13. The polyethylene composition of claim 1, wherein the second ethylene copolymer has a density of from 0.950 to 0.970 g/cm³.

14. The polyethylene composition of claim 1, wherein the first ethylene copolymer has a melt index, I₂, of <0.5 g/10 min.

15. The polyethylene composition of claim 1, wherein the second ethylene copolymer has a melt index, I₂, of >10.0 g/10 min.

16. The polyethylene composition of claim 1, wherein the ratio of the number of short chain branches per 1000 carbon atoms (SCB1/1000 Cs) in the first ethylene copolymer to the number of short chain branches per 1000 carbon atoms (SCB2/1000 Cs) in the second ethylene copolymer is >10.

17. The polyethylene composition of claim 1, wherein first ethylene copolymer is made with a single site catalyst.

18. The polyethylene composition of claim 1, wherein the second ethylene copolymer is made with a single site catalyst or a Ziegler-Natta catalyst.

19. The polyethylene composition of claim 1, wherein the polyethylene composition has hafnium residues present in at least 0.050 ppm based on the weight of the polyethylene composition.

20. The polyethylene composition of claim 1, wherein the polyethylene composition has a long chain branching factor, LCBF, of >0.0050.

21. The polyethylene composition of claim 1, wherein the polyethylene composition has a shear thinning index, SHI(1.100), of ≥7.5.

22. The polyethylene composition of claim 1, wherein the polyethylene composition has a shear thinning index, SHI(1.100), of ≥10.0.

23. The polyethylene composition of claim 1, wherein the polyethylene composition has a relative elasticity, G′/G″, at 0.05 rad/s of ≤0.50.

24. The polyethylene composition of claim 1, wherein the polyethylene composition has Izod impact strength of >1.5 foot pounds per inch.

25. The polyethylene composition of claim 1, wherein the polyethylene composition has a melt strength of ≥3.0 cN.

26. The polyethylene composition of claim 1, wherein the polyethylene composition has an environmental stress crack resistance, ESCR of greater than 1000 hours as determined by ASTM D1693 in 100% IGEPAL CO-630 under conditions A and B.

27. The polyethylene composition of claim 1, wherein the polyethylene composition has flexural secant modulus at 1% of ≥1000 MPa.

28. A polyethylene composition comprising:
(i) from 5 to 50 weight % of first ethylene copolymer having a weight average molecular weight, Mw, of >200,000 g/mol; and
(ii) from 95 to 50 weight % of a second ethylene copolymer;
wherein the first ethylene copolymer has a higher weight average molecular weight, Mw than the second ethylene copolymer;
wherein the first ethylene copolymer has a higher number of short chain branches per 1000 carbon atoms (SCB1) than the second ethylene copolymer (SCB2);
wherein the polyethylene composition has a density of >0.945 g/cm³; a melt index, 12, of from 0.8 to 4.0 g/10 min; a melt flow ratio, I₂₁/I₂, of ≥50; a molecular weight distribution, Mw/Mn, of <6.5; a Z-average molecular weight, Mz, of ≥250,000 g/mol; a Z-average molecular weight distribution, Mz/Mw, of >2.5; a long chain branching factor, LCBF, of >0.0010; a composition distribution breadth index, CDBI₅₀, of <50%; an Izod impact strength of >3.0 foot pounds per inch; and an environmental stress crack resistance, ESCR, of greater than 1000 hours as determined by ASTM D1693 in 100% IGEPAL CO-630 under conditions A and B.

29. A polyethylene composition comprising:
(i) from 5 to 50 weight % of first ethylene copolymer having a weight average molecular weight, Mw, of >200,000 g/mol; and
(ii) from 95 to 50 weight % of a second ethylene copolymer;
wherein the first ethylene copolymer has a higher weight average molecular weight, Mw than the second ethylene copolymer;
wherein the first ethylene copolymer has a higher number of short chain branches per 1000 carbon atoms (SCB1) than the second ethylene copolymer (SCB2);
wherein the polyethylene composition has a density of ≥0.945 g/cm³; a melt index, 12, of from 0.8 to 4.0 g/10 min; a melt flow ratio, I₂₁/I₂, of ≥50; a molecular weight distribution, Mw/Mn, of <6.5; a Z-average molecular weight, Mz, of ≥250,000 g/mol; a Z-average molecular weight distribution, Mz/Mw, of >2.5; a long chain branching factor, LCBF, of >0.0010; a composition distribution breadth index, CDBI₅₀, of >60%; an Izod impact strength of >1.5 foot pounds per inch; and an environmental stress crack resistance, ESCR, of greater than 400 hours as determined by ASTM D1693 in 100% IGEPAL CO-630 under conditions A and B.

30. A cap or closure prepared from the polyethylene composition of claim 1.

31. A rotomolded article prepared from the polyethylene composition of claim 1.

32. A foamed article prepared from the polyethylene composition of claim 1.

33. A cap or closure prepared from the polyethylene composition of claim 28.

34. A cap or closure prepared from the polyethylene composition of claim 29.

35. A rotomolded article prepared from the polyethylene composition of claim 28.

36. A rotomolded article prepared from the polyethylene composition of claim 29.

37. A foamed article prepared from the polyethylene composition of claim 28.

38. A foamed article prepared from the polyethylene composition of claim 29.
